(19) United States
(12) Patent Application Publication
(10) Pub. No.: US 2006/0004616 A1
(43) Pub. Date: Jan. 5, 2006

(54) Method and system for solution design and recording medium

(76) Inventors: Yasunori Yamashita, Yokohama (JP); Kenichi Funaki, Tokyo (JP); Toshiyuki Sakuma, Kawasaki (JP); Hiroyuki Konno, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/141,240

(22) Filed: Jun. 1, 2005

(30) Foreign Application Priority Data
Jun. 1, 2004 (JP) 2004-162753

(51) Int. Cl. G06Q 90/00

(52) U.S. Cl. 705/7

(57) ABSTRACT

A solution design method and system for designing solution specification and estimating a period and a price speedily on the basis of customer needs, the budget of solution, the target period of implementation of solution, etc. The customer budget or period is used as a constraint so that a gap between solution specification as the customer's request and solution specification in consideration of the constraint is clarified so that tasks and resources taking charge of each other are clarified to satisfy the quality required by the customer. Individual resource conditions are set in consideration of priority of each solution task. The settings themselves can be changed arbitrarily in accordance with the customer needs. The definition of resource ranks in each customer can be executed again on the prerequisite of the customer's request or the like. While the prerequisite is clarified, design of solution specification and estimation can be performed simultaneously without assignment of resources.

### BACKGROUND OF THE INVENTION

The present invention relates to a solution design method, a solution design computer system and a recording medium for designing a solution specification (process for performing solution) as to what solution is necessary for a customer and estimating the price of the solution and the period required for implementation of the solution when a solution to a customer problem in solution business is proposed and implemented.

As conventional solution specification design, estimation, management reform aiding techniques, there are known “System Product Sales Aid System and System Product Sales Aid Method” in JP-A-2002-230370, “Price Estimating System, Price Estimating Method, and Price Estimating Program” in JP-A-2002-318941, “Solution Model Information Generating Aid System” in JP-A-2002-175313, “Solution Providing System and Method” in JP-A-2002-342618, U.S. Pat. No. 6,591,257, and US 2003/0055696A1.

By these techniques, for example, with respect to software development and system construction, past estimation data or data in which estimation is separated from an actual result of implementation can be used and a mechanism for aiding factor analysis to examine why estimation is separated from the actual result can be used for correcting the estimation to improve accuracy.

It is further possible to aid the estimation acquisition act inclusive of other companies' products and services and present a list of tasks for performing management reform with the budget (investment) or target benefit as a constraint.

As for enterprise management, there has been increasing enterprises in which various kinds of solutions are implemented to execute management reform to strengthen the enterprise quality to attain improvement in management efficiency and improvement in customer service (CS).

A solution vendor which is a company for providing solution often provides a versatile approach as well as the solution vendor prepares consulting, system construction, project management, software provision/development, hardware apparatus provision/development, implementation construction, operation and maintenance, and other services as a solution menu in order to solve a problem of each customer. Customer needs are so multifarious that there are a number of solutions corresponding to the number of customers because the customer needs must be coped with individually.

Of course, most of such solution menus strongly have a personal aspect. In the case of design of solution specification, it is essential to design a solution process (sequence of execution of solution tasks, etc.) as well as software and hardware and to set resources (conditions such as the number of resources, resource ranks, etc.) necessary for execution of each task.

Description will be made on the assumption that solution specification contains these elements.

To propose a solution to a customer, the price and period (up to when the solution must be completed) of the solution must be estimated as well as solution specification concerned with customer-dependent solution must be designed. On this occasion, for example, it is necessary to go through the steps of: (1) grasping the degree of progress as to what state of management reform phase is the current customer state; (2) clarifying customer needs by hearing with respect to the problem; (3) designing solution specification while selecting solution menus and solution tasks required in the future on the basis of the customer needs; (4) performing estimation in consideration of the customer budget and period; (5) correcting the solution while discussing with the customer about the estimation result; and (6) offering the finally corrected solution as a formal solution specification and an estimate to the customer side.

As described above, solutions are so individual that the solutions cannot be decided unless steps are done to a certain degree. The sales of solutions are basically different from the unbundled sales of software and hardware or from the bundled sales of software and hardware.

For this reason, a lot of elements must be considered. Unless how many days are required when how many persons of what resource rank (skill, experience, knowledge, etc.) do the solution is clarified in a short time in accordance with each solution task, it is difficult to design solution specification and estimate the price and period speedily and accurately. Moreover, it is difficult to get an answer uniquely because the aforementioned condition changes in accordance with the property of each solution task and customer needs.

Moreover, even the same resource may correspond to a high rank to some customer but may correspond to a lower rank to the other customer because of the difference between the customer conditions (range to be reformed, needs, etc.). It is therefore impossible to indiscriminately estimate the price and period in the same condition.

In addition, because it is difficult to assign resources in the stage of estimation (before acceptance of an order), the price and period must be estimated without assignment of these resources.

Even in the same customer, the range to be reformed may be widened, directionality may be changed or the budget and period may be changed because an ambiguous customer condition takes shape gradually as the customer condition is asked through a hearing sheet or the like by performing several steps. Therefore, design of solution specification and estimation must be made in a different condition whenever the condition is changed.

It is a matter of course that the customer himself or herself takes part in promotion of management reform. While a certain solution is executed actually, the place charged on the customer side must be clarified so that the aimed reform can be promoted within the customer budget. Naturally, solution specification must be designed while agreement on the charged places is made.

It is however very difficult to design solution specification and estimate the price and period while conditions peculiar to various solutions are changed dynamically in consideration of the above description. Actually, while the solution specification itself is unchanged each time as the customer's request, only the price is balanced with the customer's budget. Or design of specification and estimation may be made by the responsible person's experience and inspiration. That is, there is the situation in which it is impossible to find any clear basis for the design of specification and estimation.

However, a long time is taken for estimation because each solution has the aforementioned characteristic. For this reason, the case where a business chance is lost because the company is defeated in competition to other companies is not rare.

Moreover, in such a solution that the estimated price is only fitted to the customer budget without change of solution specification, there arises easily a problem that it is impossible to do necessary things while the solution is executed, and that considerable burdens are imposed both on the solution vendor side and on the customer side. (That is, accuracy of solution specification is low.)

However, when the solution specification is designed and the price and period are estimated, there are the following problems which cannot be solved by the aforementioned background-art techniques.

Firstly, it is impossible to design the solution specification and estimate the price and period (up to when the solution must be completed) with the period used as a constraint as well as the customer budget.

Secondly, it is impossible to design the solution specification and estimate the price and period while responsible persons on the solution vendor side and on the customer side are clarified.

Thirdly, it is impossible to design the solution specification and estimate the price and period in consideration of different characteristics of solution tasks.

Fourthly, it is impossible to design the solution specification and estimate the price and period in the case where different conditions (the number of resources, resource ranks, etc.) are set in accordance with solution tasks.

Fifthly, it is impossible to design the solution specification and estimate the price and period in the case where a plurality of conditions in the aforementioned conditions are changed simultaneously.

Sixthly, it is impossible to design the solution specification and estimate the price and period in the case where resource ranks (skill, experience, knowledge, etc.) are changed dynamically in accordance with the difference in the customer conditions (range to be reformed, needs, etc.).

Seventhly, it is naturally impossible to perform the design of solution specification and the estimation of the price and period simultaneously.

The price and period must be estimated in a short time without assignment of resources while the aforementioned problems are solved.

### SUMMARY OF THE INVENTION

In view of the aforementioned problems, an object of the present invention is to provide a solution design method and system in which design of solution specification and estimation of the price and period can be made in a short time in consideration of various individual conditions provided from various customers.

In the solution design method and system according to the invention to solve the problems, the customer budget or period is used as a constraint so that a gap between solution specification as the customer's request and solution specification in consideration of the constraint is clarified so that tasks and resources taking charge of each other are clarified to satisfy the quality required by the customer. Individual resource conditions (the number of resources, resource ranks, etc.) are set in consideration of priority of each solution task. The settings themselves can be changed arbitrarily in accordance with the customer needs etc. The definition of resource ranks in each customer can be executed again on the prerequisite of the customer's request or the like. While the prerequisite is clarified, design of solution specification and estimation can be performed simultaneously without assignment of resources.

The invention provides a solution design method using a calculation execution portion in which simulation software for calculation of solution design is installed, and a user operation portion connected to the calculation execution portion, the method comprising the steps of: narrowing a solution menu necessary for a customer by inputting customer reform phase data indicating the stage of management reform of the customer from the user operation portion (solution menu narrowing step); selecting a task to be executed in solution from the narrowed solution menu and setting the degree of significance of the task (solution task selection step); setting solution design conditions of a budget, a period and a design logic as customer's constraints (solution design condition setting step); re-defining resource rank definition data in accordance with a customer's request to perform solution design in a customer-dependent condition on the basis of data concerned with the solution design conditions and the customer's request (resource rank calculation processing step); calculating a customer-dependent period each task as a period necessary for execution of the task and calculating a customer-dependent function to set allocation of resources on the basis of the customer-dependent period and the shape of a basal function (customer-dependent period and function calculation processing step); performing solution design in accordance with the customer's request in a non-constraint condition on the basis of data concerned with the customer's request, the solution task and the customer-dependent function (standard type design processing step); performing solution design with the budget which is a constraint condition of the customer, as a constraint condition (budget observance constraint type design processing step); performing solution design with the period which is a constraint condition of the customer, as a constraint condition (period observance constraint type design processing step); performing solution design again by adding/deleting solution tasks to/from processing results generated by the standard type design processing step, the budget observance constraint type design processing step and the period observance constraint type design processing step and by changing allocation of resources each task and setting customer resources (re-calculation execution step); and outputting a result of solution design as a file and item management data to a data storage device (result output step).

In the invention, the result output step outputs different solution tasks, allocation of resources each task, a difference between prices and a difference between periods as a result of the standard type design and a result of the budget observance constraint type design or the period observance constraint type design.

In the invention, each of the standard type design processing step, the budget observance constraint type design processing step and the period observance constraint type design processing step simultaneously outputs a solution process in which tasks to be executed in solution are arranged in order of execution, a period, allocation of resources and a price necessary for execution of each task, types of hardware and software used, and a price and a period required between start of the solution and completion of the solution.

According to the invention, in the solution design method and system, there can be provided a method in which a solution process, allocation of resources each solution task, and the estimated price and period can be output simultaneously in a short time with the customer budget or period as a constraint condition while the condition is changed on the basis of the customer reform phase and needs.

### BRIEF DESCRIPTION OF THE DRAWINGS

FIG. 1 is a configuration diagram showing a solution design system which is provided as an embodiment of the invention and which comprises a calculation execution portion in which solution design calculation simulation software is installed, and a user operation portion connected to the calculation execution portion by a wide area network or by a control portion or the like.

FIG. 2 is a flow chart showing an example of an overall processing procedure of a solution design method executed by use of the solution design system depicted in FIG. 1.

FIG. 3 is a flow chart showing an example of a basal processing procedure of a resource rank calculation process according to the invention.

FIG. 4 is a flow chart showing an example of a basal processing procedure for generating a customer-dependent period and a customer-dependent function according to the invention.

FIG. 5 is a flow chart showing an example of a basal processing procedure of a standard type design according to the invention.

FIG. 6 is a flow chart showing an example of a processing procedure for judging whether design of period observance constraint type/budget observance constraint type (other than standard type design) is required or not, according to the invention.

FIG. 7 is a flow chart showing an example of a basal processing procedure of a budget observance constraint type design according to the invention.

FIG. 8 is a flow chart showing an example of a basal processing procedure of a period observance constraint type design according to the invention.

FIG. 9 is a flow chart showing an example of a design processing procedure for setting customer resources according to the invention.

FIG. 10 is a configuration diagram showing an example of data in which a solution menu is defined according to the invention.

FIG. 11 is a configuration diagram showing an example of SCOPE data (customer needs data process 1) in which customer needs data are processed according to the invention.

FIG. 12 is a configuration diagram showing an example of FOCUS data (customer needs data process 2) in which customer needs data are processed according to the invention.

FIG. 13 is a configuration diagram showing an example of preset data 1 for processing coefficients of customer needs data or the like according to the invention.

FIG. 14 is a configuration diagram showing an example of preset data 2 set for performing solution design each solution task according to the invention and data for judging a flag at the time of design.

FIGS. 15A to 15D are configuration diagrams showing an example of preset data 3 showing the shape of a basal function according to the invention.

FIG. 16 is a configuration diagram showing an example of coefficient data (preset data 4) with respect to a combination of specific solution tasks according to the invention.

FIG. 17 is a configuration diagram showing an example of data (SCOPE, FOCUS mapping data) (preset data 5) indicating correlation of affecting customer needs each solution task according to the invention.

FIG. 18 is a configuration diagram showing an example of criterion data 1 for defining resource ranks according to the invention.

FIG. 19 is a configuration diagram showing an example of criterion data 2 for defining resource ranks according to the invention.

FIG. 20 is a configuration diagram showing an example of resource rank definition data 1 and resource number list data each resource rank according to the invention.

FIG. 21 is a configuration diagram showing an example of resource rank definition data 2 according to the invention.

FIG. 22 is a configuration diagram showing an example of data (needs selection definition data) for pegging customer phases, solution menus and tasks according to the invention.

FIG. 23 is a configuration diagram showing an example of a log-in screen (estimation start screen) according to the invention.

FIG. 24 is an image diagram showing an example of a customer reform phase selection screen according to the invention.

FIG. 25 is an image diagram showing an example of a customer needs input screen (SCOPE (essential) data input, FOCUS (selection) data input) according to the invention.

FIG. 26 is an image diagram showing an example of a solution task selection screen according to the invention.

FIG. 27 is an image diagram showing an example of a solution essential task setting screen according to the invention.

FIG. 28 is an image diagram showing an example of a solution design condition setting screen according to the invention.

FIG. 29 is an image diagram showing an example of a solution design result display screen according to the invention.

FIG. 30 is an image diagram showing an example of a solution design difference confirmation display screen according to the invention.

FIG. 31 is an image diagram showing an example of a solution process change screen according to the invention.

FIG. 32 is an image diagram showing an example of a solution resource setting change screen according to the invention.

FIG. 33 is a configuration diagram showing an example of solution design result difference data according to the invention.

### DETAILED DESCRIPTION OF THE EMBODIMENTS

Embodiments of the invention will be described below with reference to the accompanying drawings.

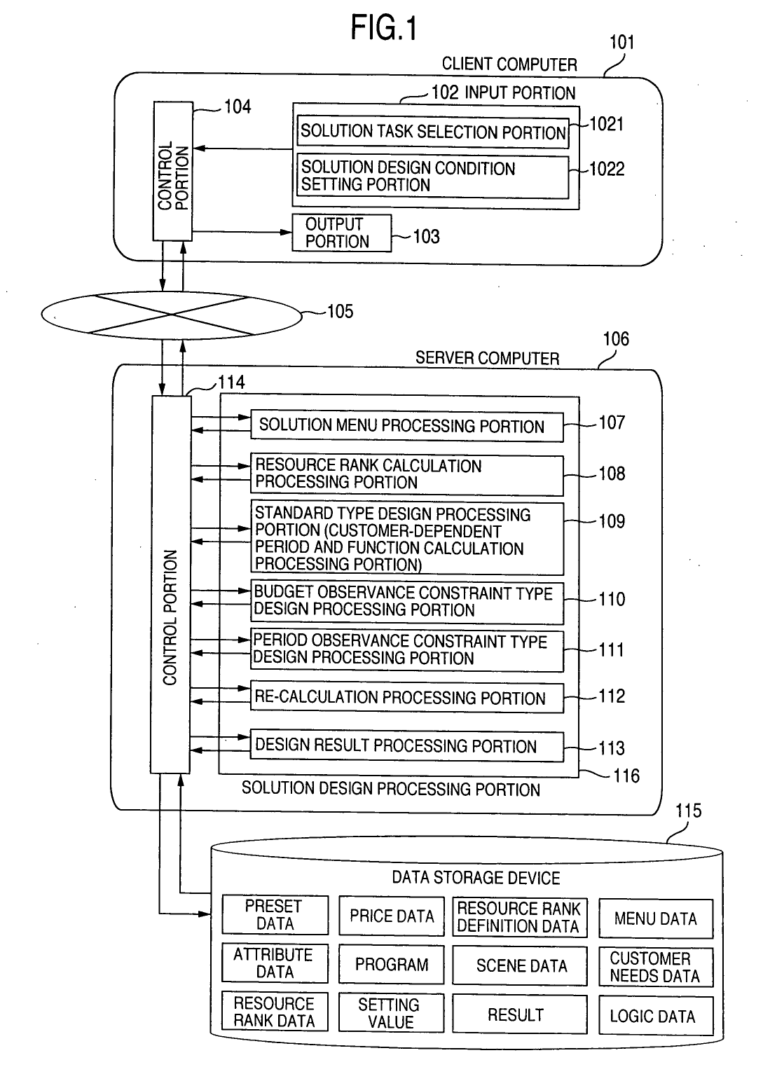

FIG. 1 is a configuration diagram showing a solution design system according to an embodiment of the invention. The solution design system comprises a calculation execution portion in which a simulation software for calculation of solution design is installed, and a user operation portion connected to the calculation execution portion by a wide-area communication network or by a control portion or the like.

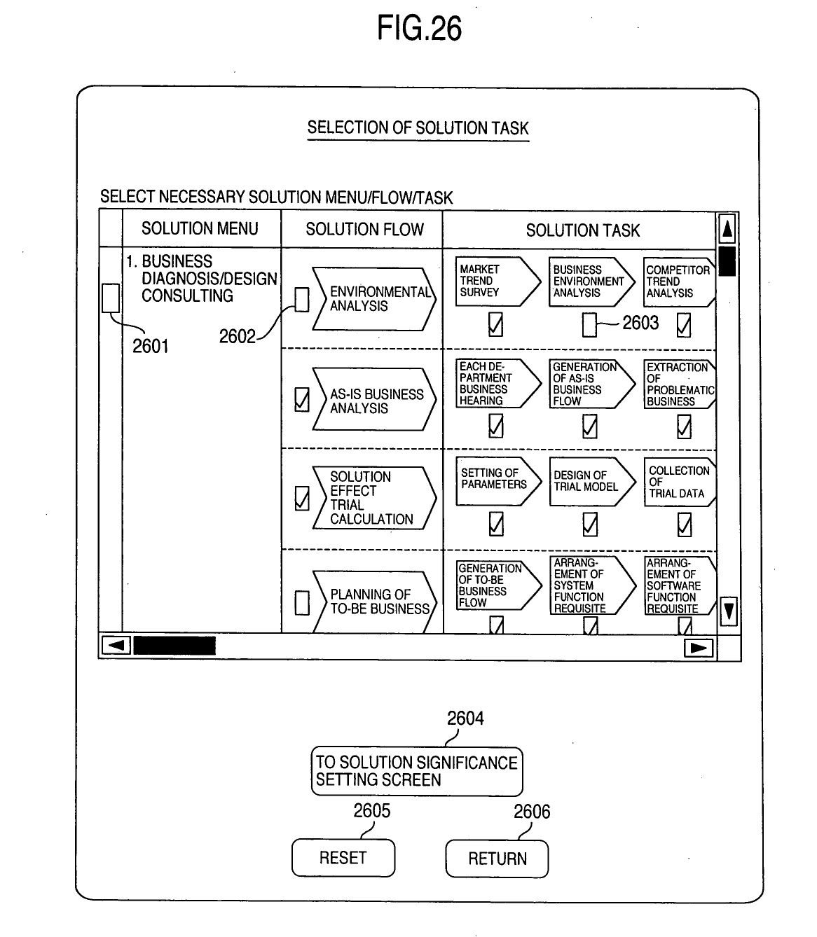

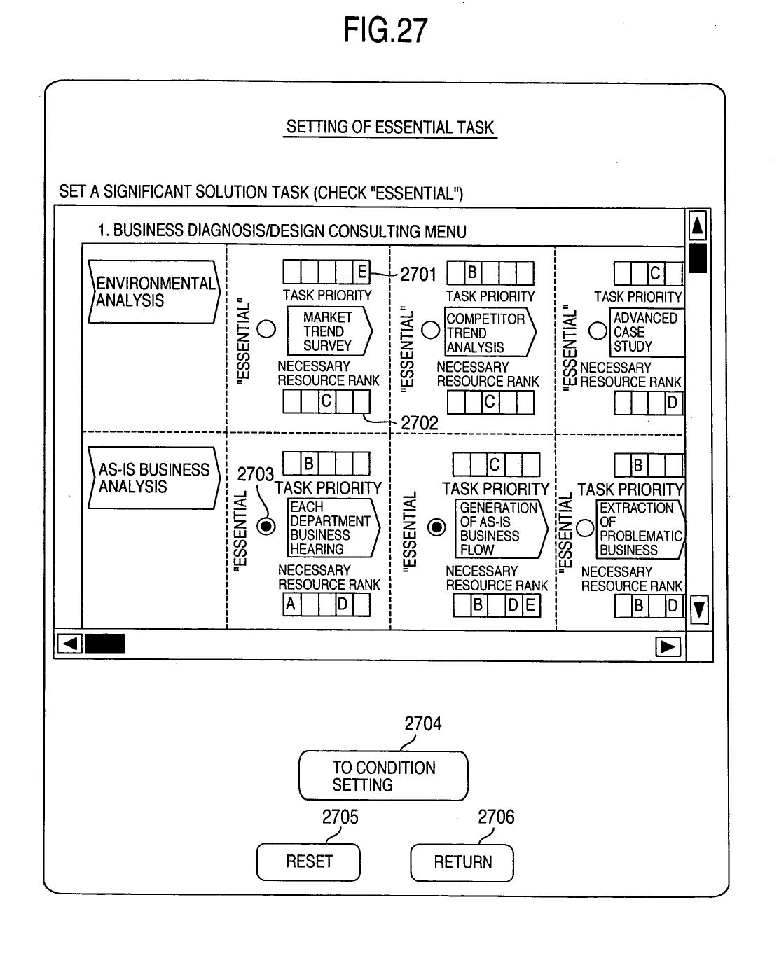

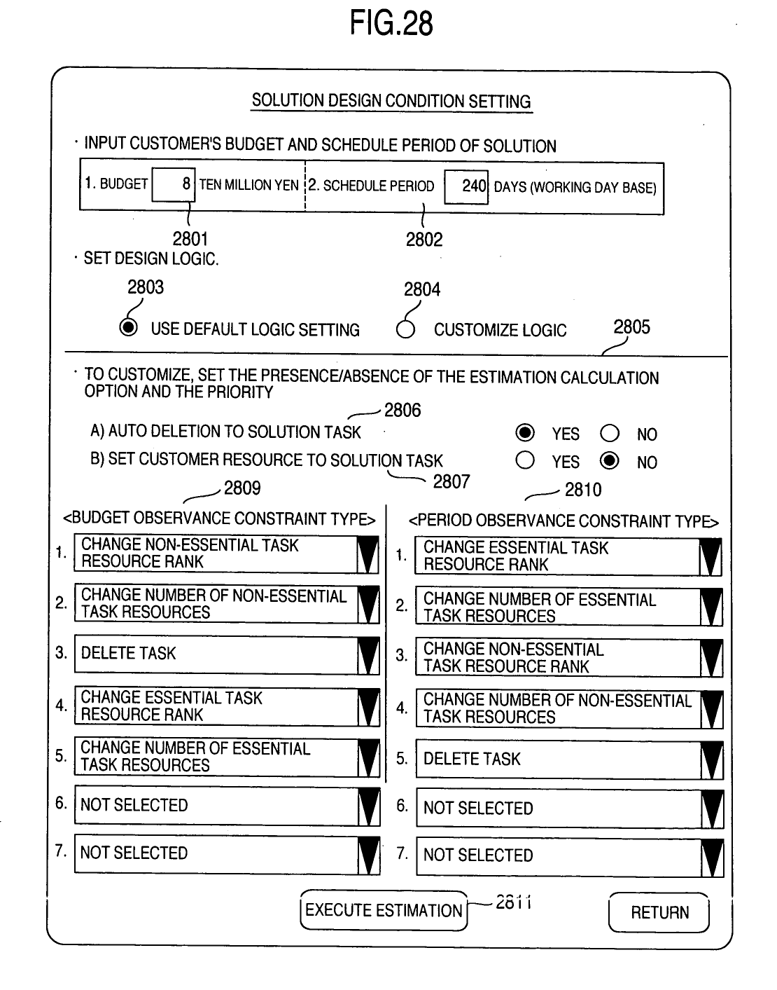

An input portion 102 in a client computer 101 accepts data and files from a user as input necessary for design and estimation of solution specification. The input portion 102 also accepts instructions (e.g. solution task/essential task selection result (S209) and solution design/condition setting result (S210)) from the user as input concerned with execution of design and estimation of solution specification. The term “S” hereinafter means “step”. That is, the input portion 102 functionally has a solution task selection portion 1021 using scenes shown in FIGS. 26 and 27, and a solution design condition setting portion 1022 using a scene shown in FIG. 28.

Incidentally, the term “user” used in the invention means a person responsible in a sales department, in a consulting department or in a sales engineering department for design and estimation of solution specification or means a customer etc. as occasion demands.

A control portion 104 in the client computer 101 has a function of transmitting the data and files accepted by the input portion 102 to a server computer 106 side through a communication network 105, and a function of receiving result data of design and estimation of solution specification from the server computer 106 side and transferring the result data to an output portion 102.

The output portion 103 in the server computer 101 has a function of displaying or printing the result of design and estimation of solution specification.

A control portion 114 in the server computer 106 receives input data from the client computer 101 side through the communication network 105 and transfers the input data to a data storage device 115. The control portion 114 reads the input data from the data storage device 115, transfers the input data to a solution menu processing portion 107 and receives solution menu data as a processing result from the solution menu processing portion 107. The control portion 114 transfers the input data to a resource rank calculation processing portion 108 and receives resource rank data and resource data as a processing result from the resource rank calculation processing portion 108. The control portion 114 transfers the input data to a standard type design processing portion (inclusive of a customer-dependent period/function calculation processing portion) 109 and receives each customer-dependent period, each customer-dependent function, each customer-dependent resource allocation and a standard type design calculation result as a processing result from the standard type design processing portion 109. The control portion 114 transfers the input data, the customer-dependent period, the customer-dependent function, the customer-dependent resource allocation and the standard type design calculation result to a budget observance constraint type design processing portion 110 and receives a budget observance constraint type design calculation result as a processing result from the budget observance constraint type design processing portion 110. The control portion 114 transfers the input data, the customer-dependent period, the customer-dependent function, and the standard type design calculation result to a period observance constraint type design processing portion 111 to execute step S218 and receives a period observance constraint type design calculation result as a processing result from the period observance constraint type design processing portion 111. The control portion 114 transfers the input data, the standard type design calculation result, the budget observance constraint type design calculation result, the period observance constraint type design calculation result and setting change data to a re-calculation processing portion 112 and receives a design re-calculation result as a processing result from the re-calculation processing portion 112. The control portion 114 transfers the respective design calculation results due to the aforementioned control to a design result processing portion 113. The control portion 114 transmits data as a result of processing by the design result processing portion 113 to the client computer 101 side through the communication network 105 or transfers the data to a data storage device 115.

The solution menu processing portion 107 in the server computer 106 narrows the solution menu necessary for design of solution specification and estimation of price from the input data transferred from the control portion 114 and transfers the narrowed solution menu to the control portion 114 (S206).

The solution rank calculation processing portion 108 in the server computer 106 re-defines resource ranks in accordance with the customer's needs from the input data transferred from the control portion 114, calculates the required number of resources and the over-and-short number of resources in accordance with each resource rank and transfers resource rank data and the resource data as a processing result to the control portion 114 (S214).

The standard type design processing portion 109 in the server computer 106 processes a period necessary for execution of a solution task and setting of a function for defining resource allocation and the period in accordance with customer's needs and each task from the input data transferred from the control portion 114, calculates the design of solution specification based on the standard type design basal flow and the estimated period and price from the customer-dependent period and the customer-dependent function as a processing result, and the input data, judges from the standard type design calculation result as a processing result whether the budget observance constraint type design/period observance constraint type design is required or not, and transfers the standard type design calculation result as a processing result, the customer-dependent period, the customer-dependent function and the budget observance constraint type design/period observance constraint type design judgment result to the control portion 114 (S215 and S216).

The budget observance constraint type design processing portion 110 in the server computer 106 calculates the design of solution specification and the estimated period and price in accordance with the setting of the design condition, on the basis of the budget observance constraint type design basal flow when the budget observance constraint type design is required, from the budget observance constraint type design/period observance constraint type design judgment result and the standard type design calculation result transferred from the control portion 114, and transfers the budget observance constraint type design calculation result as a processing result to the control portion 114 (S217).

The period observance constraint type design processing portion 111 in the server computer 106 calculates the design of solution specification and the estimated period and price in accordance with the setting of the design condition, on the basis of the period observance constraint type design basal flow when the period observance constraint type design is required, from the budget observance constraint type design/period observance constraint type design judgment result and the standard type design calculation result transferred from the control portion 114, and transfers the period observance constraint type design calculation result as a processing result to the control portion 114 (S218).

The re-calculation processing portion 112 in the server computer 106 re-calculates only a portion where the resource setting or resource task is changed, from the input data, the standard type design calculation result, the budget observance constraint type design calculation result, the period observance constraint type design calculation result and the setting change data transferred from the control portion 114 and transfers the design re-calculation result as a processing result to the control portion 114 (S226)

The design result processing portion 113 in the server computer 106 generates a file as a collection of the design of solution specification and the estimated result from the input data, the standard type design calculation result, the budget observance constraint type design calculation result, and the period observance constraint type design calculation result or the design re-calculation result transferred from the control portion 114, generates data for registering the design of solution specification and the estimated result in an item DB and transfers the design result file and the item data as a processing result to the control portion 114.

The data storage device 115 stores the input data transferred from the control portion 114 in the server computer 106, transfers data necessary for processing performed by each processing portion in the server computer 106 and stores data as a result of processing executed by each processing portion in the server computer 106.

The solution design processing portion 116 executed on the basis of a solution design program in the server computer 106 functionally has a solution menu processing portion 107, a resource rank calculation portion 108, a standard type design processing portion 109, a budget observance constraint type design processing portion 110, a period observance constraint type design processing portion (inclusive of a customer-dependent period and function calculation processing portion) 111, a re-calculation processing portion 112, and a design result processing portion 113.

In the aforementioned configuration, the client computer 101 and the server computer 106 perform predetermined processes respectively to thereby achieve the present invention. The data storage device 115 may be included in the server computer or may be included in the client computer.

Incidentally, the input portion 102 and the output portion 103 in the client computer 101 may be provided in the server computer 106 instead so that the same process as that of the control portion 104 can be executed by the control portion 114 without interposition of the communication network 105 to thereby achieve the present invention. In this case, the data storage device 115 is provided on the server computer side. Or a plurality of client computers 101 may be provided so that a plurality of users can execute a program in the server computer 106 to thereby achieve the present invention. When a necessary process is performed on an input screen, the input portion 102 of the client computer 101 may use a display application such as Java (registered trademark) on the screen to achieve the present invention.

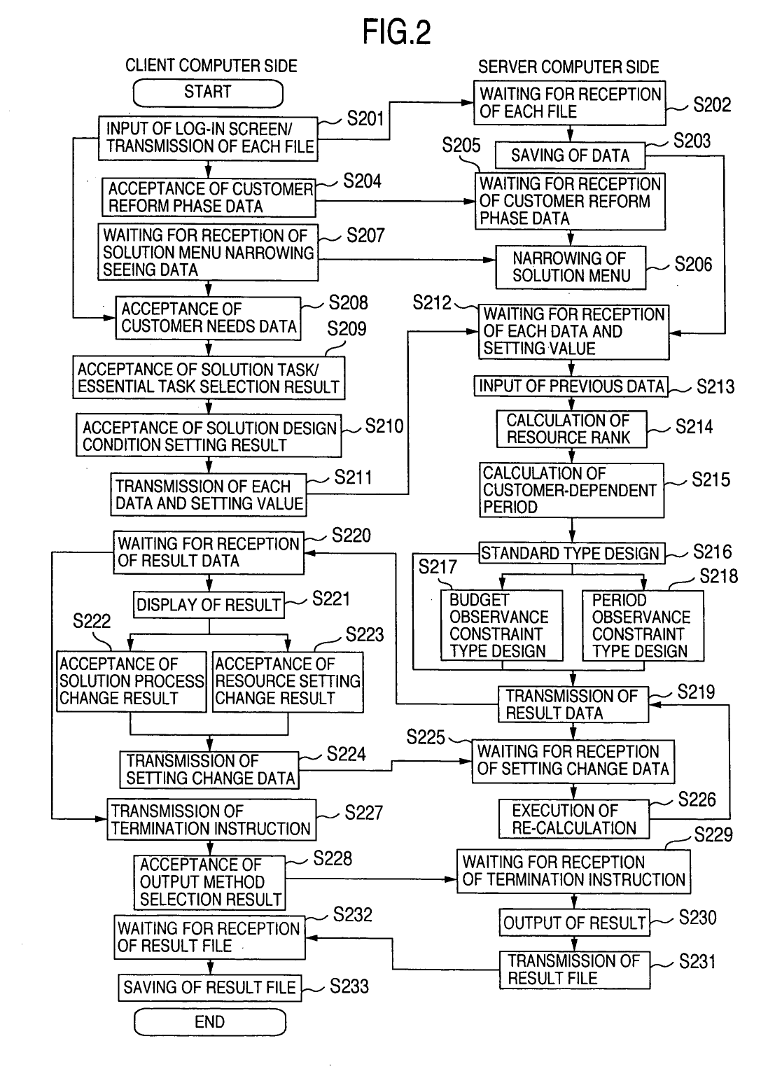

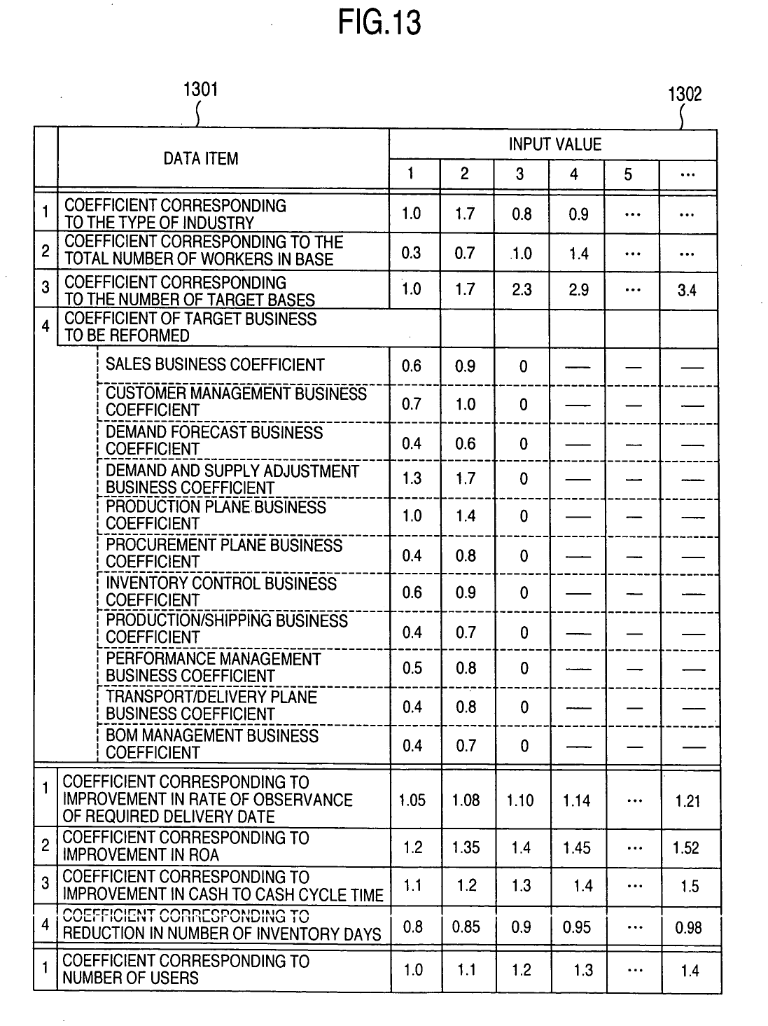

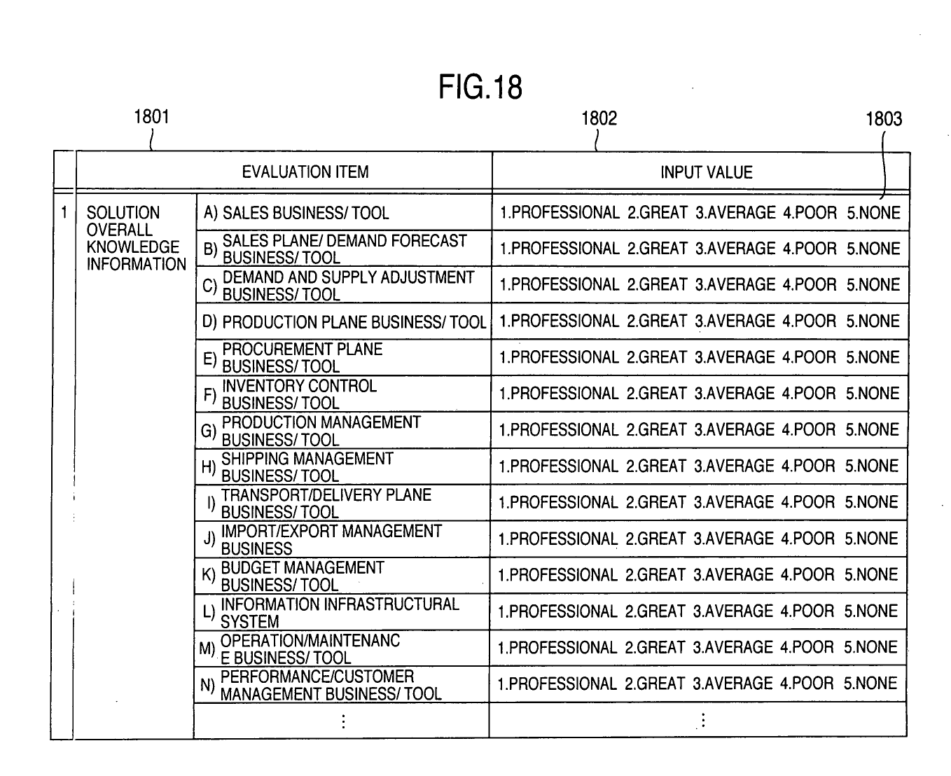

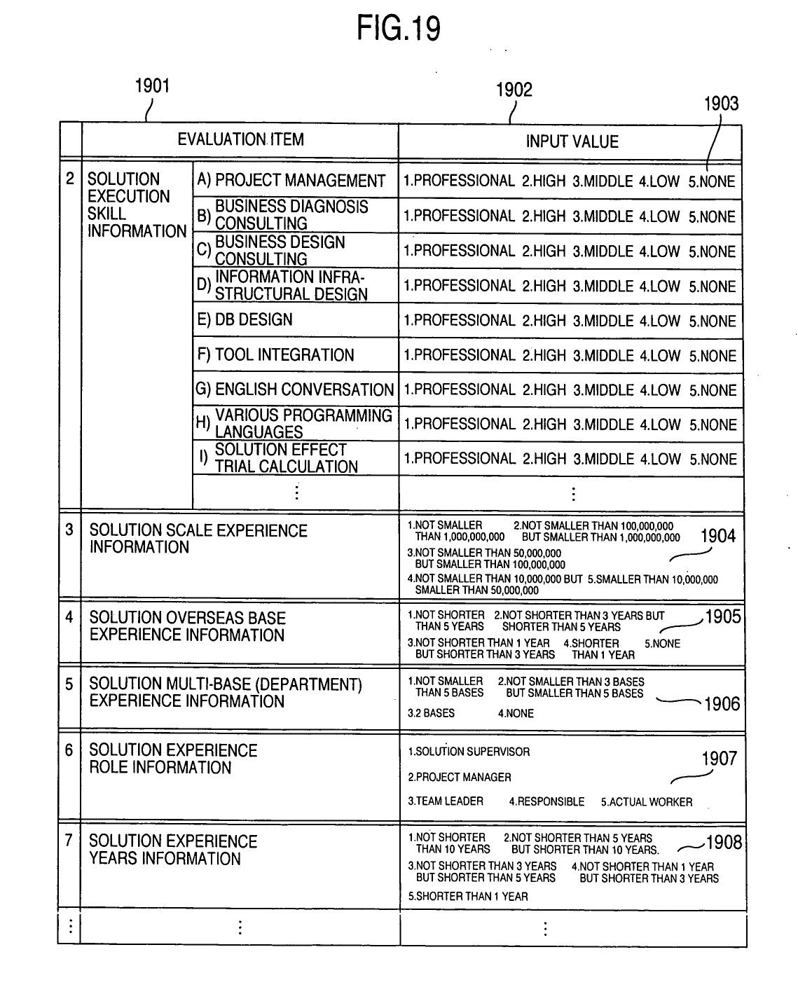

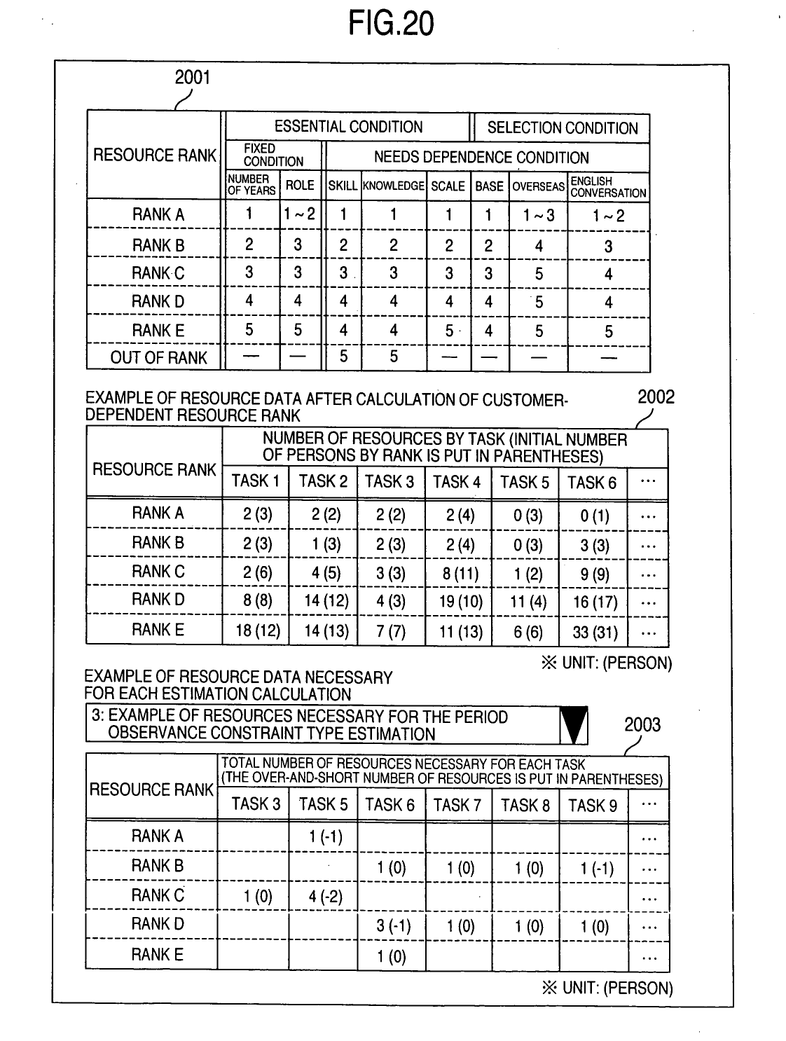

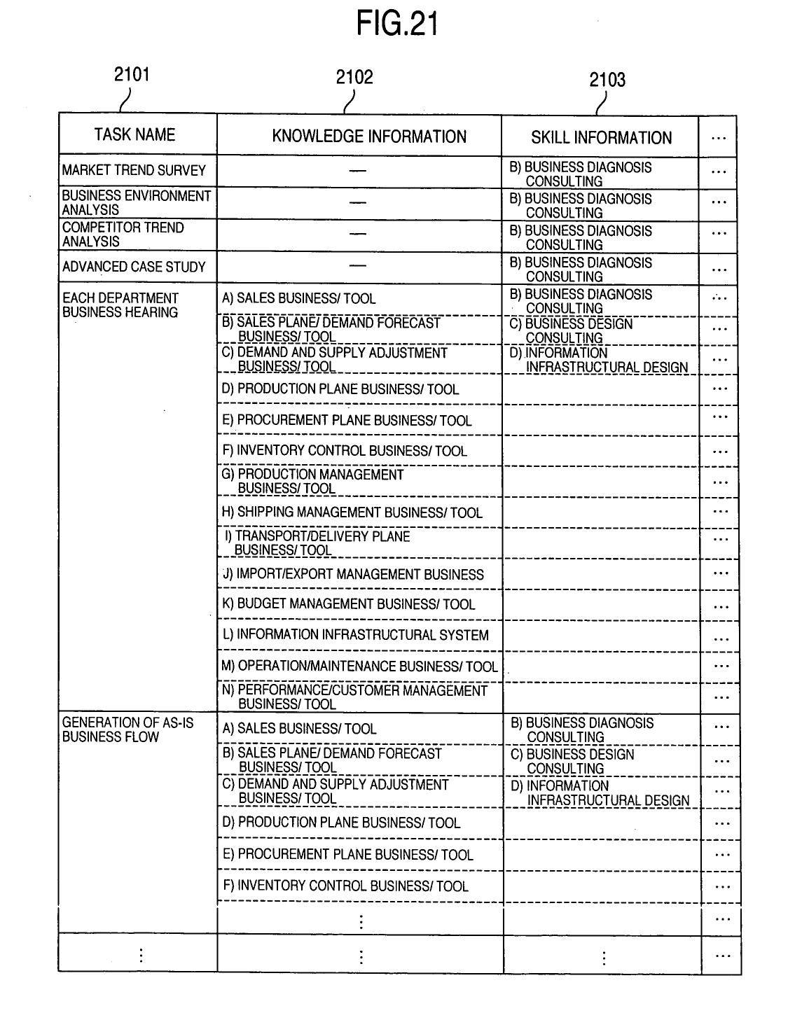

Next, a processing flow achieved by the client computer 101 and the server computer 106 will be described with reference to FIG. 2. As for the solution menu (type of solution necessary for the customer), there may be conceived consulting, system construction, project management, software provision/development, hardware apparatus provision/development, implementation construction, operation and maintenance, and provision of other services. Before this process, the user prepares an input data file for solution menu definition data (FIG. 10 shows a specific example of [menu 1] business diagnosis/design consulting, [menu 2] system construction, [menu 3] reform project management, [menu 4] infrastructural system construction, [menu 5] hardware implementation, [menu 6] operation and maintenance, [menu 7] management strategy planning and consulting, etc.), preset data 1 to 5 (shown in FIGS. 13 to 17) for defining coefficient, function, period and unit price, etc. necessary for design of solution specification and calculation of estimated period and price, and criterion data 1 (FIG. 18) to 2 (shown in FIG. 19) and resource rank definition data 1 (FIG. 20) to 2 (FIG. 21) for defining resource ranks. FIGS. 10 to 22 show an example of the contents of the input data.

Description will be made in accordance with the processing flow shown in FIG. 2.

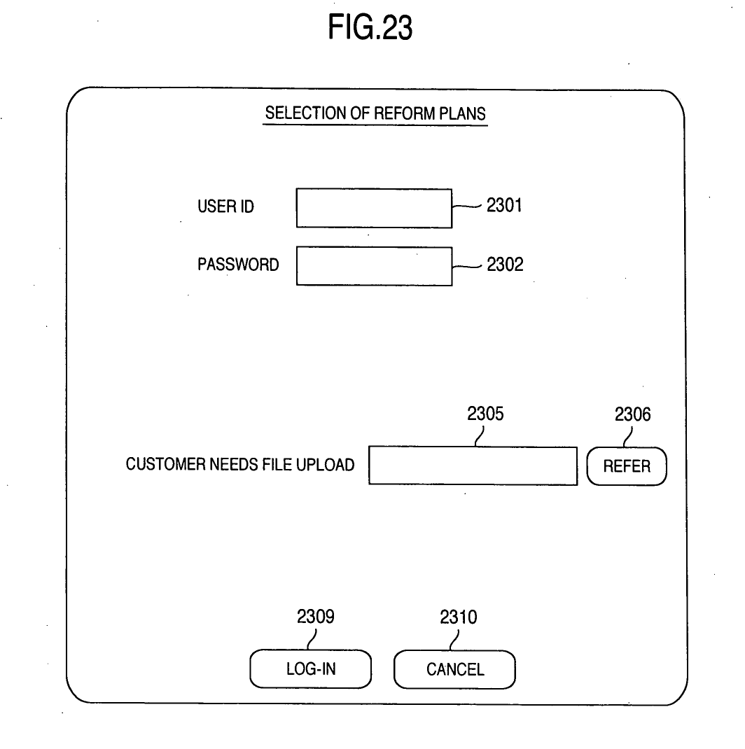

The server computer 106 in an initial state waits for reception of the file transmitted from the client computer 101 (S202). In the client computer 101, when a log-in button 2301 is pushed after a user ID and a password are input on a log-in screen (FIG. 23) and a customer needs file path name is input if necessary, these data are transmitted to the server computer 106 (S201). The server computer 106 waiting for reception receives these data and stores these data of each file in the data storage device 115 (S203).

Incidentally, when a needs hearing file path name is input, the current position of processing goes to acceptance of customer needs data (S208). On this occasion, information such as ID added to the file name for identifying a specific customer is used for reading customer solution menu narrowing data (which will be described below) from the server computer 106.

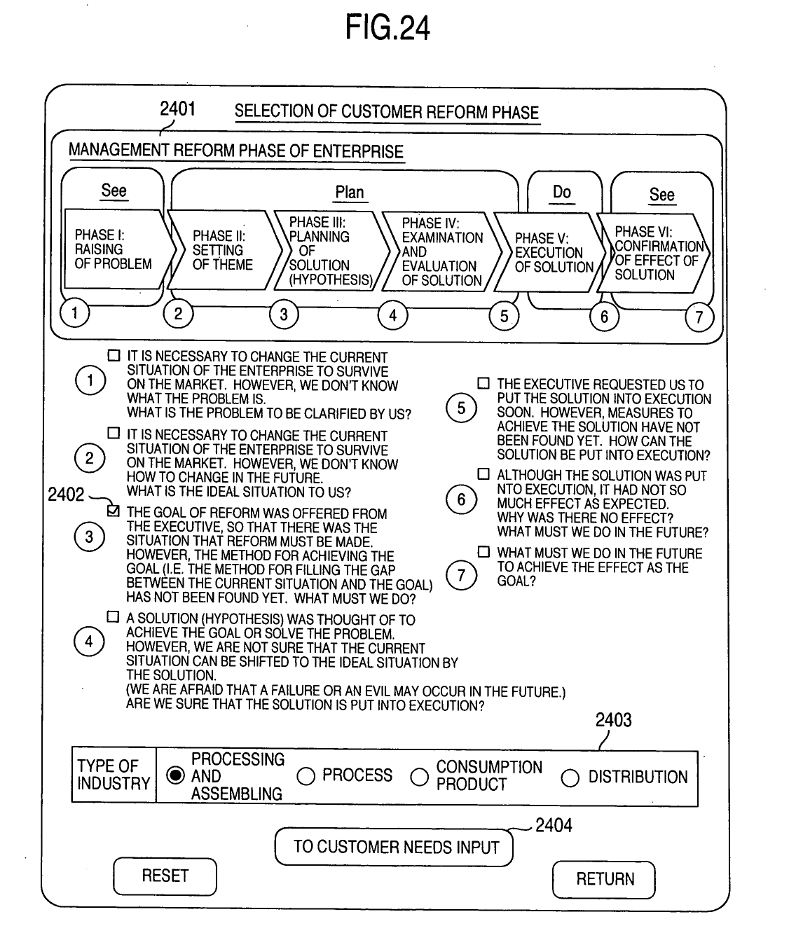

In acceptance of customer needs data, a solution design program to be executed by the solution design processing portion 116 of the server computer 106 is started to generate a customer reform phase selection screen shown in FIG. 24 and sends the customer reform phase selection screen to the client computer 101. When the user checks the type of customer's industry and the degree of progress of reform closest to the actual reform phase in enterprise reform in a check box such as a check box 2402 on the customer reform phase selection screen (FIG. 24), the client computer 101 generates industry type data and customer reform phase data (S204). As for this screen example, data indicating machining and assembling as the type of industry and data indicating customer reform phase 3 are generated.

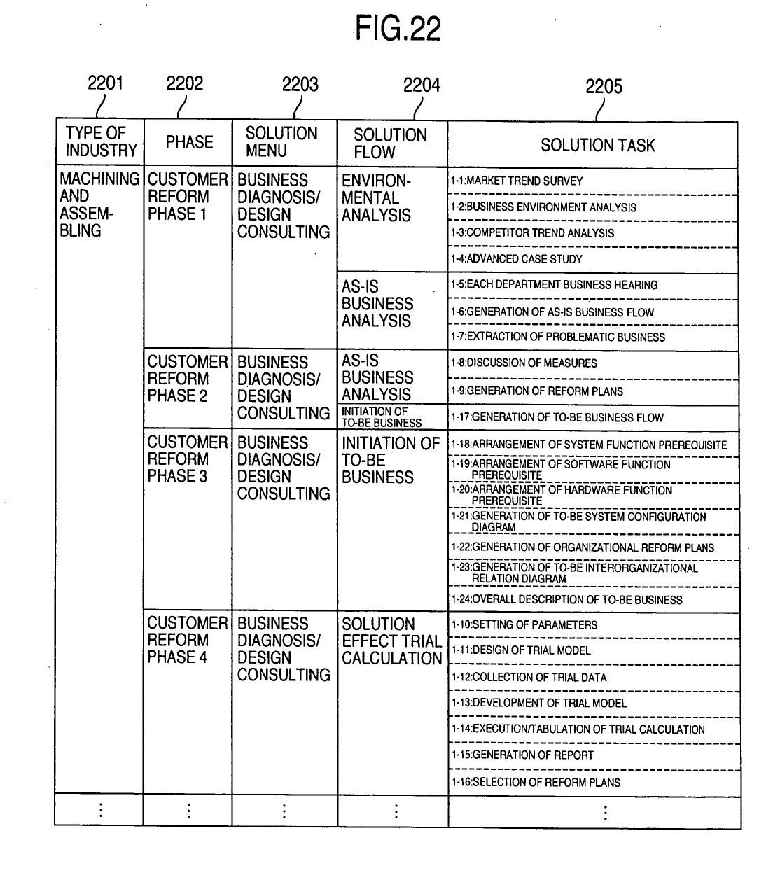

When the user pushed down the “to input customer needs” button 2404, the client computer 101 transmits the industry type data and the customer reform phase data to the server computer 106 and then waits for reception of solution menu narrowing data (S207). On the other hand, upon reception of the data, the server computer 106 waiting for reception (S205) reads needs selection definition data (FIG. 22) from the data storage device 115, narrows the solution menu (type of solution necessary for the customer) on the basis of the industry type 2201 and its data and the phase 2202 and its data in the needs selection definition data, generates the solution menu narrowing data and transmits the solution menu narrowing data to the client computer 101 (S206). The client computer 101 waiting for reception (S207) receives the data and the current position of processing goes to acceptance of customer needs data (S208).

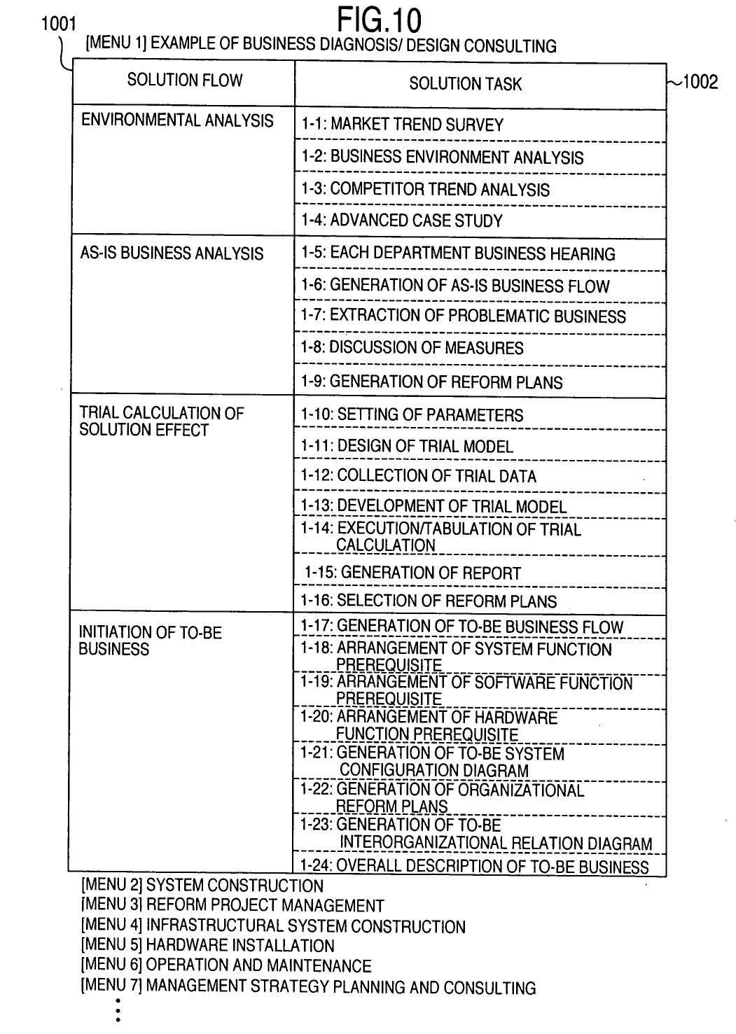

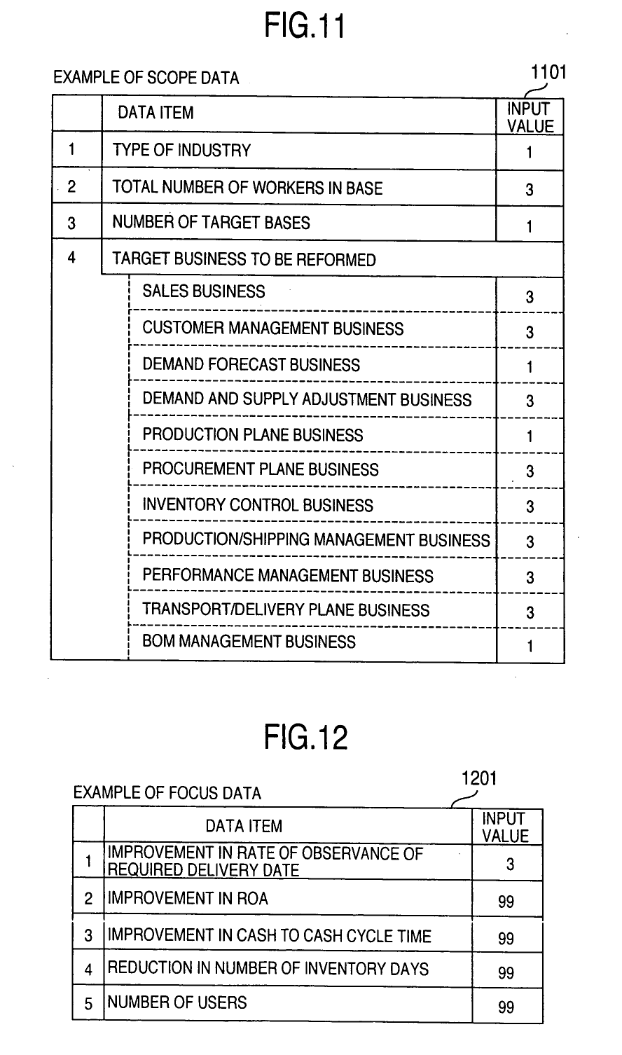

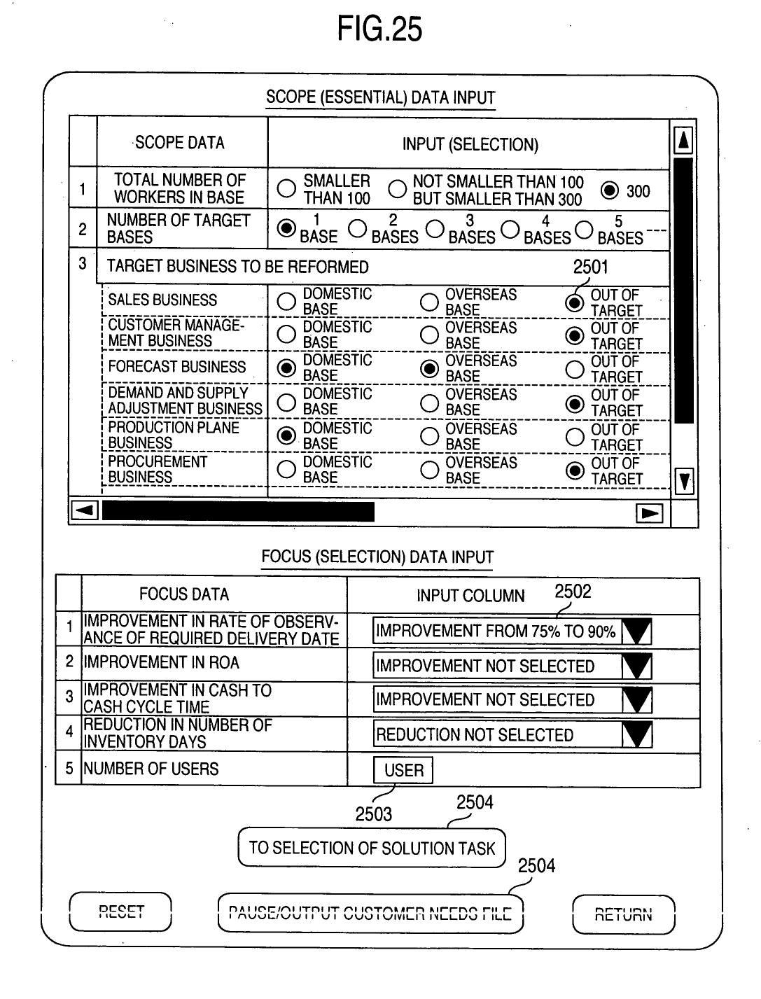

Here, the user may input the total number of workers in each base, the number of target bases, target business to be reformed, etc. as essential (SCOPE) input data by selection with a radio button such as a button 2501 on the customer needs input screen (FIG. 25), may input improvement in rate of observance of required delivery date, improvement in ROA, improvement in cash to cash cycle, reduction in number of inventory days, etc. as selection (FOCUS) data inclusive of the customer's current reform level information by selection on a pull-down menu such as a menu 2502 and may input the number of users, etc. on an input box such as a box 2503. When the button 2504 is pushed down at the stage in which inputting is completed, the client computer 106 generates customer needs data processes 1 (FIG. 11) and 2 (FIG. 12) and the current position of processing goes to acceptance of solution task/essential task selection result (S209).

Incidentally, to interrupt the inputting so temporarily that the user will restart the inputting after customer needs hearing, the user can push the button 2505 so that the design of solution specification is interrupted after a hearing customer needs file which uses the ID as its file name and in which the same item as on the customer needs input screen is written is output to the data storage device 115. To restart the design of solution specification, when the user inputs the path name for the customer needs file at the time of log-in on the log-in screen (FIG. 23) as described above, the client computer 101 generates customer needs data processes 1 and 2 from the customer needs file and displays the data input into the file on the customer needs input screen (FIG. 25). When the user pushes the button 2504 after the user confirms the input content on this screen or after the user corrects the input content, the client computer 101 generates customer needs data processes 1 and 2 again when there is any correction, and the current position of processing goes to acceptance of solution task/essential task selection result (S209).

Here, a solution task is first selected by the user on the solution task selection screen (FIG. 26) generated from the solution menu narrowing data. When the user checks a check box such as a box 2601 aside each solution menu on the solution task selection screen shown in FIG. 26, the client computer 101 checks all check boxes for solution flows and solution tasks concerned with the solution menu. When the user likewise checks a check box such as a box 2602 aside each solution flow, the client computer 101 checks all check boxes for solution tasks concerned with the solution flow.

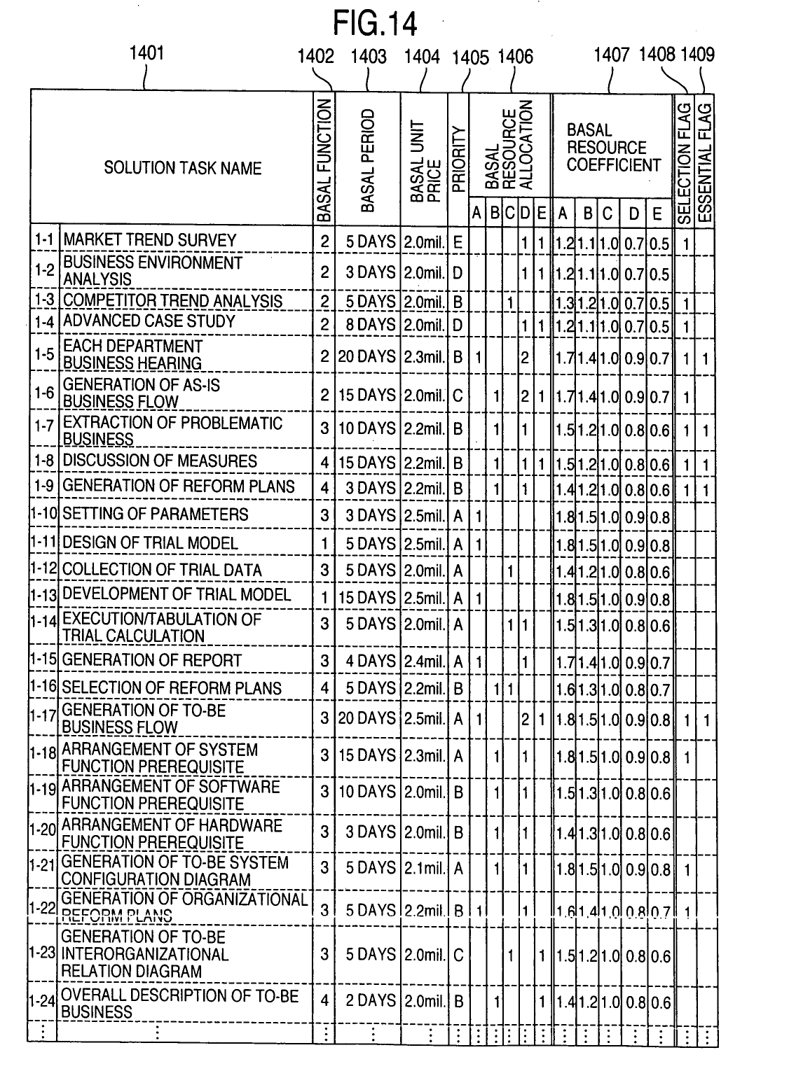

The user can select necessary solution tasks while the user uses the check boxes in such a manner that a check box such as a check box 2603 under each solution task is checked or unchecked. When the user pushes the button 260 finally, selection of solution tasks is completed. As shown in FIG. 14, the client computer 101 generates a selection flag 1408 for each selected solution task, generates a solution essential task setting screen (FIG. 27) on the basis of the task, the corresponding solution flow and solution menu for the task, the priority 1405 of preset data 2 and the basal resource allocation 1406 and displays the solution essential task setting screen.

Here, the user can select a radio button such as a button 2703 on the solution essential task setting screen shown in FIG. 27 to set whether the selected solution task is essential or not. The client computer 101 generates an essential flag 1409 for the solution task set as the essential task.

The client computer 101 also displays the task priority indicating significance of the solution task and the resource rank of each of resources necessary for execution of the task. Though not shown, the resource rank is pegged to the number of resources based on the basal resource allocation 1406.

To change the task priority, the user can change the priority written in a set of input boxes such as a set of boxes 2701. To change the necessary resource rank, the user can change the necessary resource rank written in a set of input boxes such as a set of boxes 2702 in the same manner as described above.

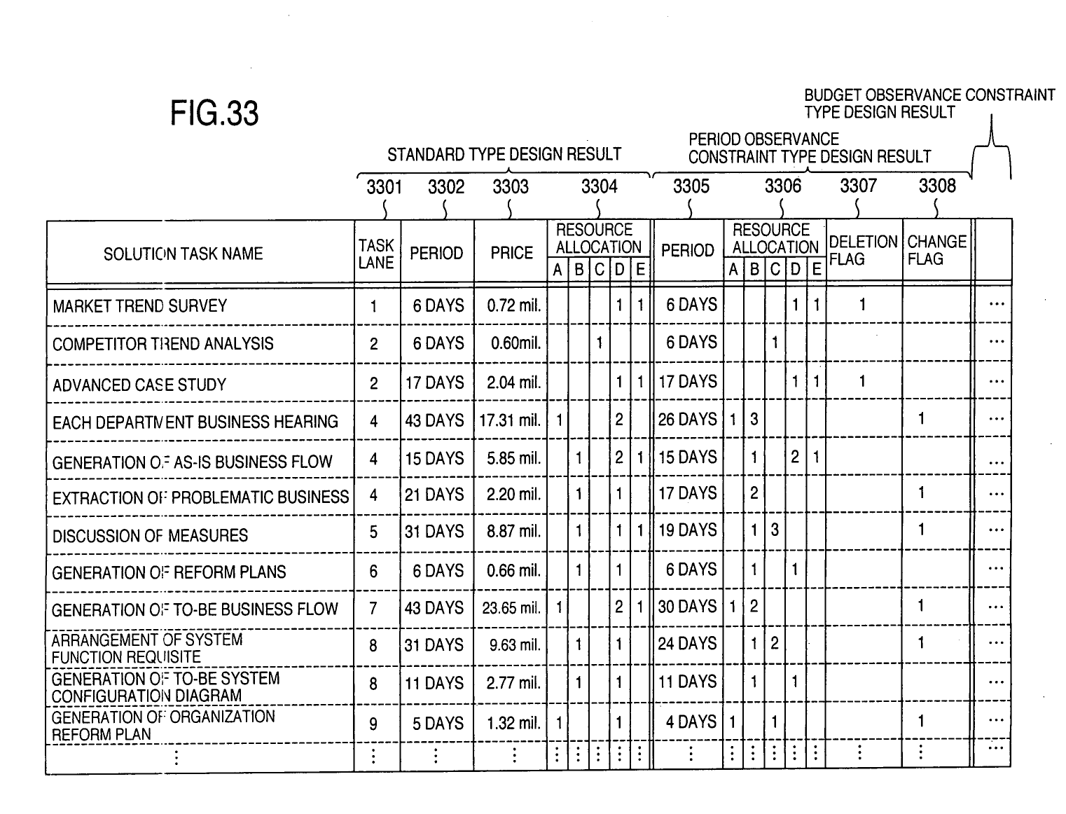

Incidentally, when the user changes the resource rank, the client computer 101 pegs the number of resources pegged to the not-changed resource rank to the changed resource rank directly. Specifically, the contents of the change are stored as the resource allocation 3304 of solution design result difference data (FIG. 33) in the data storage device 115.

Finally, when the user pushes the button 2704, the setting of the solution essential task and the changing are completed and the current position of processing goes to acceptance of solution design condition setting result (S210).

Here, on the solution design condition setting screen shown in FIG. 28, the user first inputs a customer budget and a customer schedule period for implementation of solution as a constraint for solution design. The budget is input as a numerical value in a box 2801 while the period is input as a numerical value in a box 2802. Incidentally, when the budget or period is not input, the client computer 101 sets the not input item to zero.

The user further sets a logic for design of solution specification. When a radio button 2803 is selected, solution design is performed by a default logic. The client computer 101 displays settings concerned with the default logic on a lower side under a line 2805 so that the settings cannot be selected. When a radio button 2804 is selected, the user can customize the logic on the basis of the default logic. On this occasion, the user can set options 2806 and 2807 by radio buttons as to whether each of the options 2806 and 2807 is valid or not.

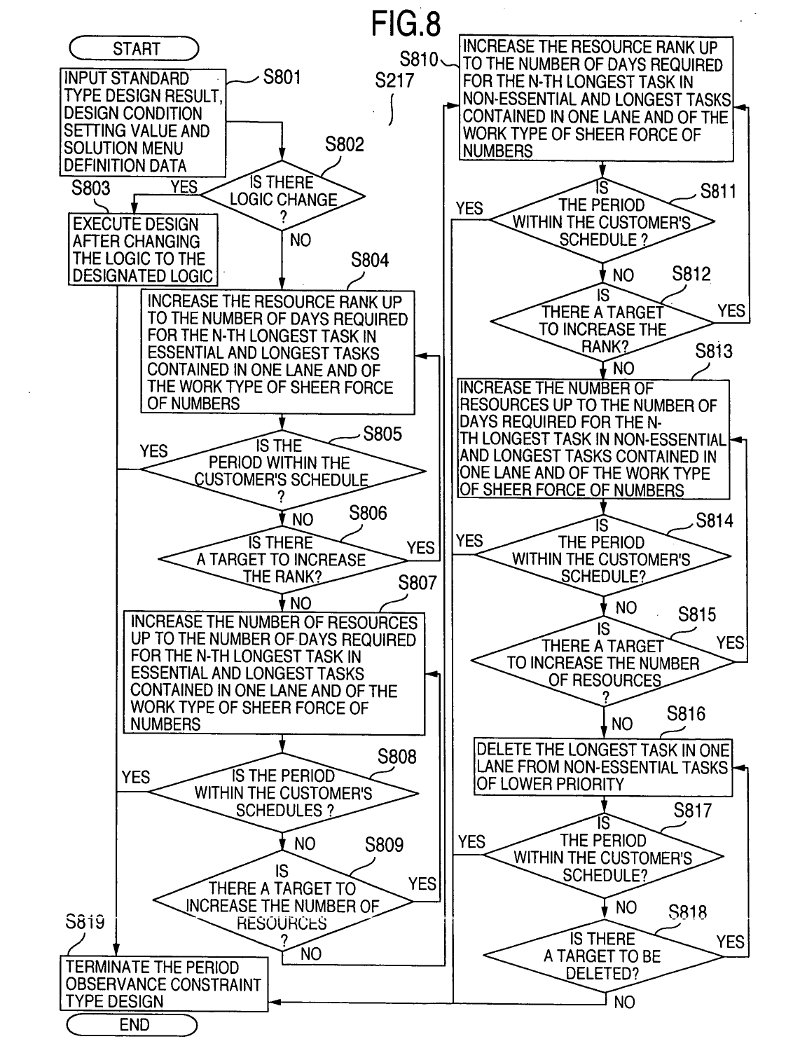

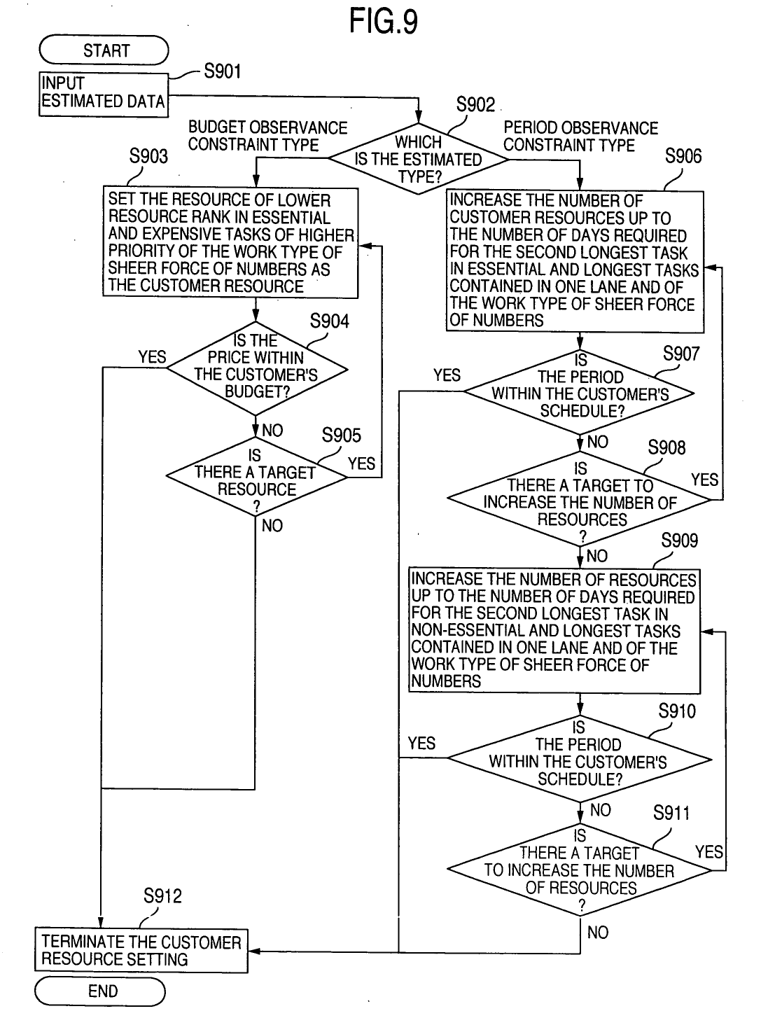

Incidentally, when the user sets the option 2807 to be valid, the client computer 101 can select the condition “Setting of Customer Resource for Solution Task (shown as a flow chart in FIG. 9)” which is not present in the default logic, on pull-down menus of budget observance constraint type priority 2809 and period observance constraint type priority 2810.

Finally, when the user pushes a button 2811, the client computer 101 generates solution design condition setting values of the budget, period, design logic, etc. and the current position of processing goes to transmission of data and setting values (S211).

Here, the client computer 101 transmits an instruction to the server computer 106 waiting for reception of data and setting values to instruct the server computer 106 to read preset data 1 to 5 (FIGS. 13 to 17), price data of tools necessary for management reform, criterion data 1 (FIG. 18) and 2 (FIG. 19) and resource rank definition data 1 (FIG. 20) and 2 (FIG. 21) from the input data stored in the data storage device 115 in addition to the customer needs data processes 1 (FIG. 11) and 2 (FIG. 12) and the design condition setting values generated in the steps S208 to S210. The server computer 106 receives the data, the setting values and the instruction (S212), so that the data and the setting values are taken in the server computer 106 (S213). After that, the current position of processing goes to calculation of resource rank (S214).

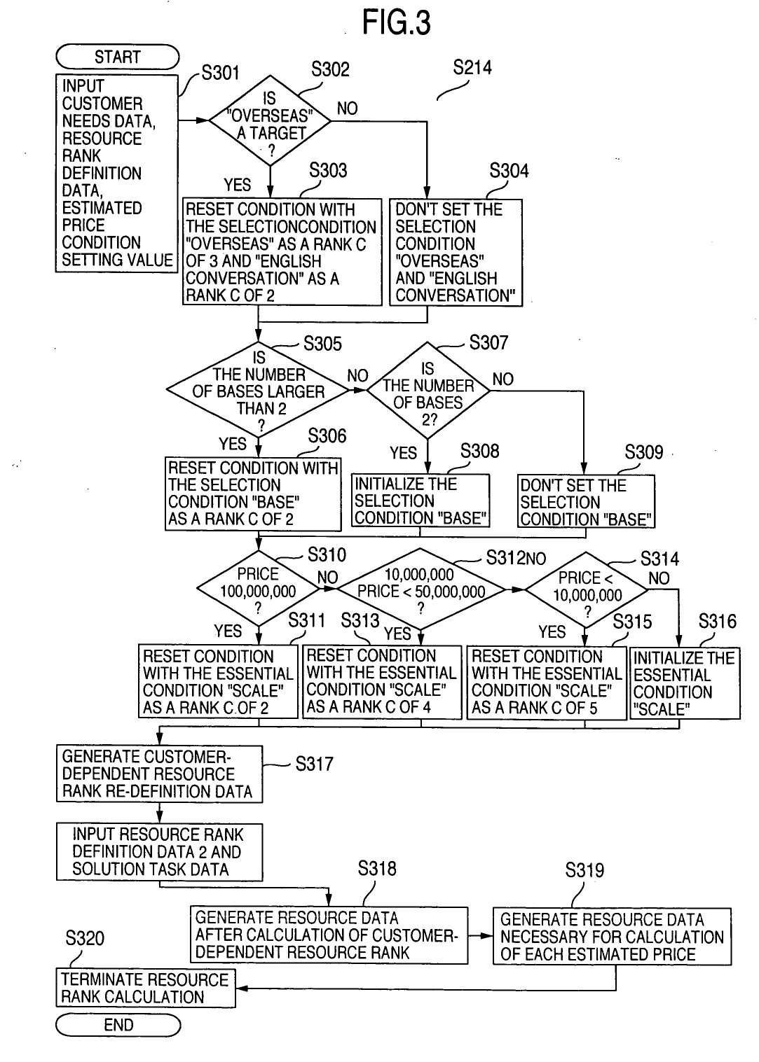

Here, as shown in FIG. 3 which is a flow chart of resource rank calculation processing, the server computer 106 inputs the customer needs data processes 1 (FIG. 11) and 2 (FIG. 12), the resource rank definition data 1 (FIG. 20) and 2 (FIG. 21) and the estimation condition setting values into the resource rank calculation processing portion 109 (S301). As shown in FIG. 20, the server computer 106 generates customer-dependent resource rank data (resource rank re-definition data 2002 and 2003 obtained by re-defining resource rank definition data 2001) on the basis of the resource rank definition data 1 (2001).

First, a judgment is made as to whether overseas is a target of reform or not (S302). When overseas is a target as a condition of selection, for example, the ranks C, E, D, B and A of “Overseas” are reset to 3, 5, 4, 2 and 1 respectively and the ranks C, D, E, B and A of “English Conversation” are reset to 2, 3, 4, 2 and 1 respectively (S303). When overseas is not a target, the conditions “Overseas” and “English Conversation” are not set (S304).

Then, when the number of target bases as a condition of selection is larger than 2 (S305), for example, the ranks C, D, E, B and A of “Base” are reset to 2, 3, 4, 2 and 1 respectively (S306). When the number of bases is 2 (S307), the rank C of “Base” is reset to the initial value (S308). When the number of bases is 1, the condition “Base” is not set (S309).

Further, when the price in the design condition setting values is not lower than 100,000,000 (S310), for example, the ranks C, D, E, B and A of “Scale” as an essential condition are reset to 2, 3, 4, 2 and 1 respectively (S311). When the price is not lower than 10,000,000 but lower than 50,000,000 (S312), the ranks C, D, E, B and A of “Scale” as an essential condition are reset to 4, 4, 5, 3 and 2 respectively (S313). When the price is lower than 10,000,000 (S314), the ranks C, D, E, B and A of “Scale” as an essential condition are reset to 5, 5, 5, 4 and 3 respectively (S315). Otherwise, the condition “Base” as an essential condition is reset to the initial value (S316). In this manner, customer-dependent resource rank re-definition data are generated (S317).

Then, the number of actual resources each solution task is calculated on the basis of resource ranks re-defined from the customer-dependent resource rank re-definition data, the selection flag (1408) of preset data 2, the resource rank definition data 2 (FIG. 21) and registration information of general sources in which criterion information such as criterion data 1 (FIG. 18) and 2 (FIG. 19) can be judged, so that the resource data (2002 in FIG. 20) are generated (S318).

After the design of solution specification is completed, a list (2003 in FIG. 20) of resource numbers in accordance with resource ranks required for estimation calculation of respective design types (standard type, period observance constraint type, budget observance constraint type, etc.) is further generated (S319) and resource rank calculation is terminated (S320). The current position of processing then goes to calculation of customer-dependent period (S215).

Incidentally, the reference numerals 2002 and 2003 in FIG. 20 are used for assisting to grasp the over-and-short number of resources before reception of an order.

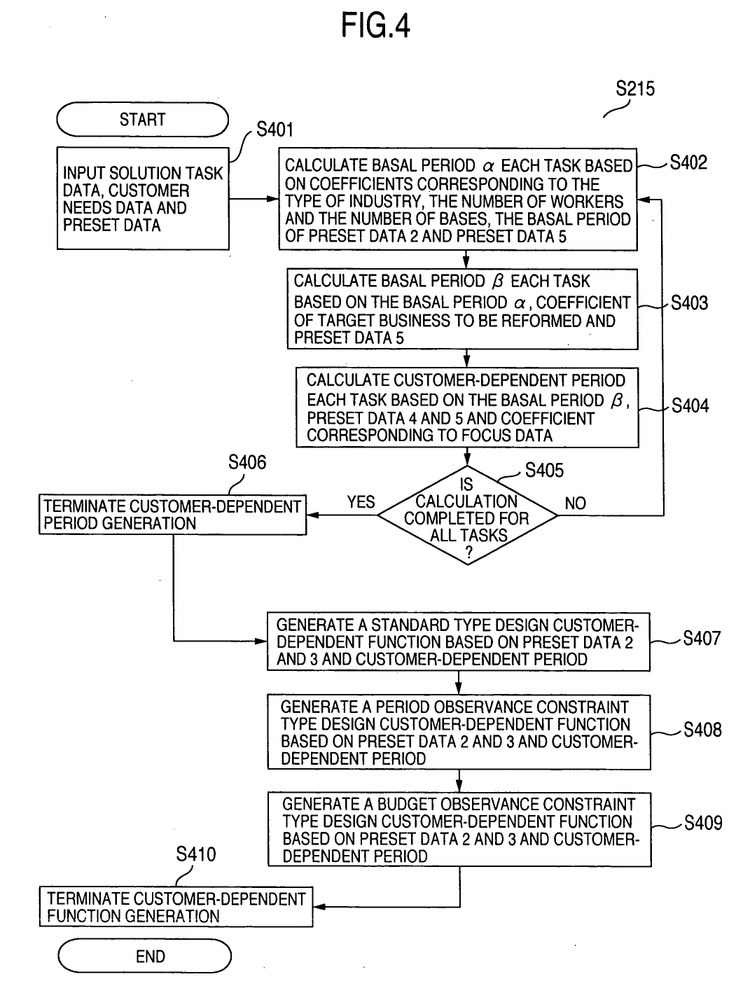

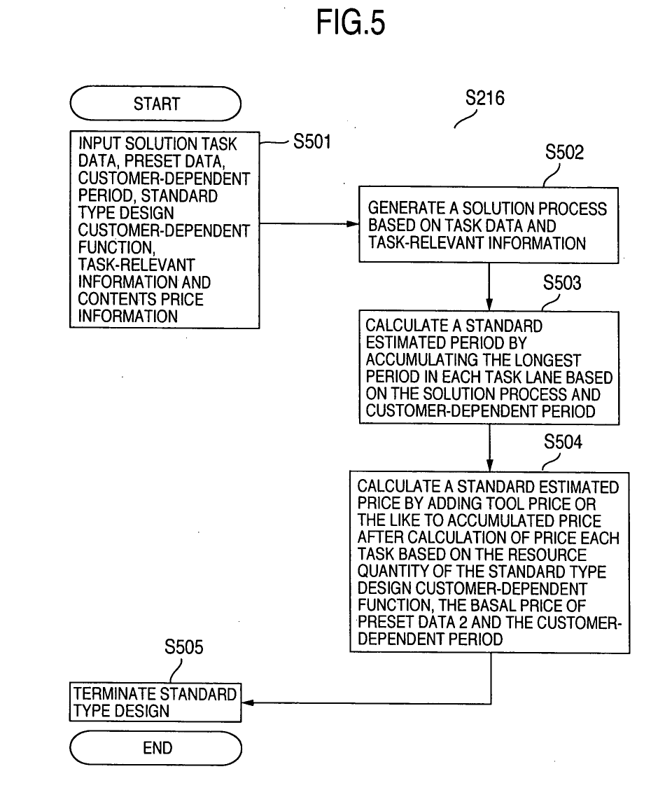

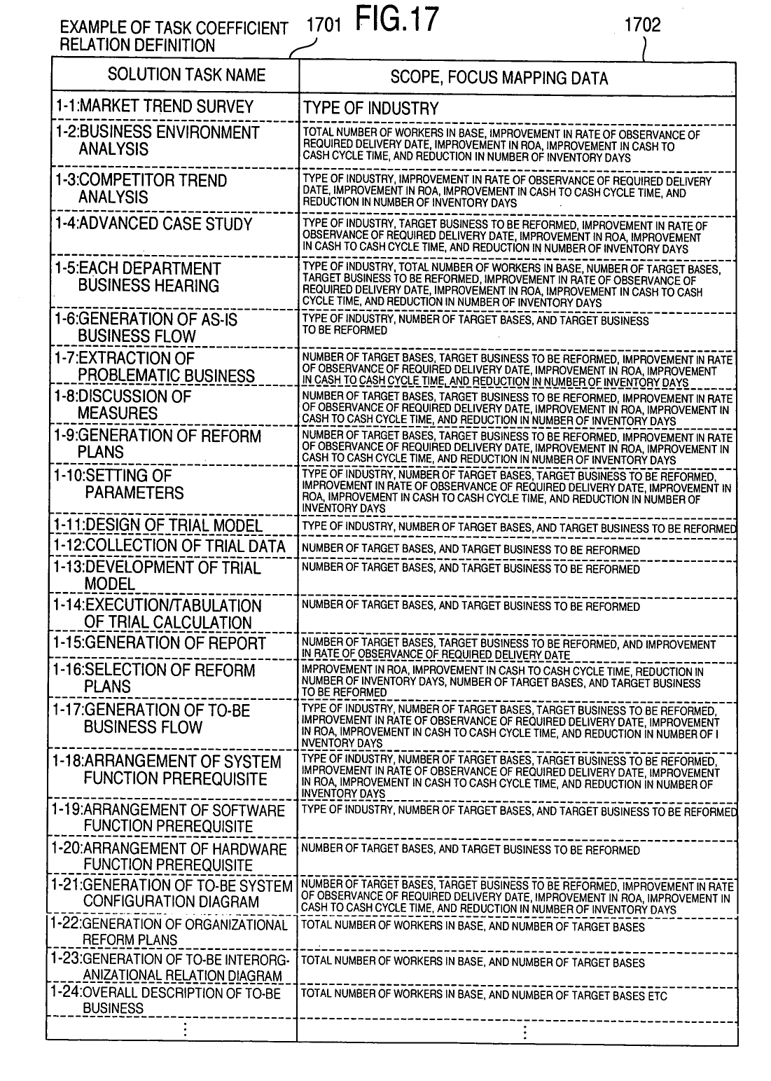

In calculation of customer-dependent period (S215), as shown in FIG. 4 which is a basal flow of generation of customer-dependent period and customer-dependent function, the server computer 106 inputs the customer needs data processes 1 (FIG. 11) and 2 (FIG. 12) and preset data 1 to 5 (FIGS. 13 to 17) into the standard type design processing portion 109 (S401), calculates customer-dependent period necessary for execution of the task based on customer needs in accordance with each selected solution task (S402 and S403) and generates a customer-dependent function for defining the period and resources (S407 to 409). “Incidentally, the following calculation is performed in accordance with each solution task.”First, basal period α=basal period 1403×(coefficient of the industry type)×(coefficient of the total number of workers in each base)×(coefficient of the number of target bases) is calculated on the basis of the customer needs data processes 1 (FIG. 11) and 2 (FIG. 12) and preset data 1 (FIG. 13), 2 (FIG. 14) and 5 (FIG. 17) (S402). On this occasion, coefficients having no coefficient relation definition in preset data 5 in FIG. 17 are excluded from calculation. That is, in S402, basal period a each solution task is calculated on the basis of coefficients corresponding to the type of industry, the number of workers, the number of bases, the basal period of preset data 2 and the preset data 5.

Then, basal period β=basal period α×first coefficient of target business to be reformed+basal period α×second coefficient of target business to be reformed + . . . +basal period α×n-th coefficient of target business to be reformed is calculated in accordance with each solution task (S403). On this occasion, n is decided by the number of target businesses to be reformed in the customer needs data process 1, the target business to be reformed having coefficient relation definition in preset data 5 in FIG. 17. That is, in S403, basal period β each solution task is calculated on the basis of the basal period α, the coefficients of target businesses to be reformed and the preset data 5.

Further, customer-dependent period=basal period β×(coefficient of specific combination)×(FOCUS coefficient) is calculated on the basis of the preset data 4 (FIG. 16) and 5 (FIG. 17) and the customer needs data process 2 (FIG. 12) (S404). On this occasion, when there is no input of FOCUS (selection) data on the customer needs input screen shown in FIG. 25, a numerical value of 99 is generated as shown in FIG. 12 and a FOCUS coefficient corresponding to 99 is set to be 1. When the solution task is not on menus of business system construction, infrastructural system construction, software implementation, etc., when a plurality of target ranges to be reformed are not selected or when a plurality of target ranges to be reformed are selected but do not match with a specific combination, the coefficient of specific combination is set to be 1. That is, in S404, customer-dependent period each solution task is calculated on the basis of the basal period β, the preset data 4 and 5 and the coefficient corresponding to FOCUS data.

When the aforementioned calculation is completed on all target tasks (S405), generation of customer-dependent period is completed (S406).

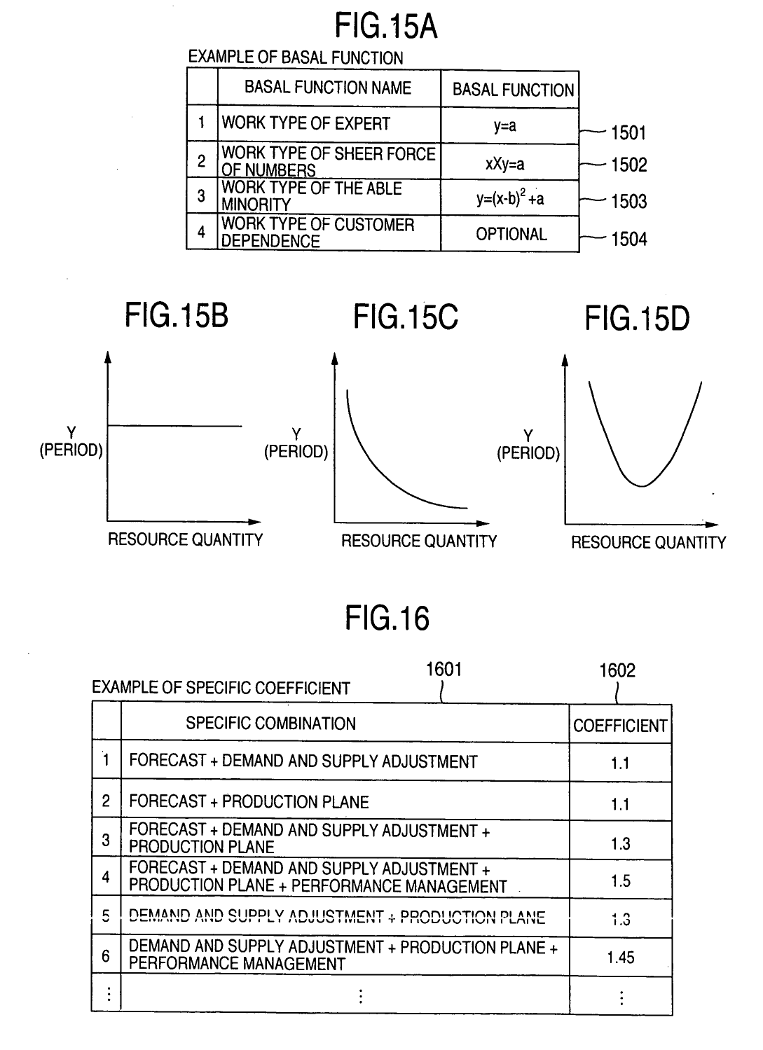

Here, the server computer 106 generates customer-dependent functions for the standard type design, the budget observance constraint type design and the period observance constraint type design respectively on the basis of the basal functions (shown in FIGS. 15A to 15D) defined in accordance with each task based on the customer-dependent period and the preset data 2 and 3 (S407, S408 and S409).

Description will be made while the task name 1-5 “each department business hearing” in FIG. 14 is taken as an example. First, from the basal function 1402 of the preset data 2 shown in FIG. 14, the task is expressed in the basal function 2, so that an inverse proportion function x×y=a which is shown in FIG. 15C and which is a function of the work type of sheer force of numbers is selected on the basis of the preset data 3 shown in FIG. 15A. Incidentally, x is the resource quantity, y is the period, and a is the task quantity. By default, x is decided on the basis of the basal resource allocation and the basal resource coefficient of the preset data 2, that is, x=number of rank A resources x coefficient of rank A resources+ . . . number of rank E resources x coefficient of rank E resources (of course, calculation is not performed on a zero resource portion in the basal resource allocation).

FIG. 15B shows a basal function of the work type of expert. FIG. 15D shows a basal function of the work type of the able minority.

Unless the necessary source rank is changed on the solution essential task setting screen (FIG. 27), x is calculated by default. If the resource rank is changed, x is calculated on the basis of the resource rank. In this embodiment, on the assumption that the resource rank is not changed, x is calculated as x=1×1.7+2×0.9=3.5. Because the basal period of each department business hearing is 20 days but the customer-dependent period in this embodiment is 43 days on the basis of the calculation in the steps S402 to S406, y is calculated as y=43. Accordingly, a=43×3.5=151 (rounded off after the decimal point). In the standard type design, the estimated period is made on the basis of the fixed values of x and y calculated in this time (S407). Incidentally, the price of the task is calculated as (resource quantity)×(basal unit price 1404)×(customer-dependent period)/20.

In this manner, the customer-dependent period each task which is a result of the standard type design is input into the period 3302 of solution design result difference data shown in FIG. 33, and the task price each task is input into the price 3303 shown in FIG. 33.

In the budget observance constraint type design, when the budget is over, the task price is intended to be reduced by lowering the resource rank without change of the customer-dependent period or reducing the number of resources, that is, reducing the resource quantity x to reduce the task quantity a. In this embodiment, therefore, a=x×y=x×43 (S408) In this case, because the quality of execution of the task is lowered, the price is reduced though the risk of excess of the customer-dependent period etc. is allowed. In practice, solution design is performed in the condition that the resource quantity x is a variable while the period y (y=43) is a fixed value, that is, the period 3302.

In the period observance constraint type design, when the period is over, the period of the task is intended to be reduced by increasing the resource rank or increasing the number of resources, that is, increasing the source quantity x to reduce the period y. In this embodiment, therefore, y=a/x=151/x (S409).

The customer-dependent function each task is input into the budget observance constraint type design result column of solution design result difference data.

In this manner, generation of the customer-dependent function is terminated (S410) and the current position of processing goes to standard type design (S216).

In the standard type design, the server computer 106 inputs solution task data (customer needs data processes 1 (FIG. 11) and 2 (FIG. 12)), preset data 1 to 5 (FIGS. 13 to 17), customer-dependent period, standard type design customer-dependent function data, task relation information and prices data into the standard type design processing portion 109 (S501). The task relation information is based on a general flow indicating parallel relation or constraint relation between tasks for deciding a solution process (a sequence of execution of solution tasks). The price data are general contents price information in which prices of contents necessary for solution such as tools and hardware necessary for execution of tasks are written. The server computer 106 arranges the selected solution tasks in the sequence of execution thereof to generate a solution process (S502). After necessary resources are set in accordance with each solution task, the server computer 106 calculates the price and period of solution (S503 and S504).

In the standard type design, design of solution specification is performed on the basis of customer needs without consideration of constraints such as period and budget.

First, the sequence of the selected tasks is judged from the selection flag 1408 shown in FIG. 14. Substantially, task numbers are given to the tasks in the solution menu definition data (FIG. 10). The tasks on the same menu need not be arranged sequentially because solution tasks may be executed in parallel. In the case of tasks on different solution menus, it is necessary to judge whether the tasks are to be executed in parallel or not. Of course, there may be tasks having a constraint relation in which some task cannot be started unless some task or some tasks finished.

Therefore, if there are tasks having a parallel relation from the task relation information, the tasks are arranged on one and the same time axis (hereinafter referred to as “task lane”) by pegging. After this arrangement is entirely finished, the tasks are arranged on task lanes before and after the tasks by pegging based on the sequential relation. After that, tasks having a constraint relation, that is, a constrained task and a constraining task are pegged to generate a solution process. Task lane information is input into the task lane 3301 of solution design result difference data shown in FIG. 33 (S502).

Then, based on the generated solution processes (task lane 3301) and the customer-dependent periods, a solution task having the longest customer-dependent period is extracted from solution tasks in one and the same task lane. The longest customer-dependent periods of extracted solution tasks in all task lanes are accumulated to calculate the standard type design estimated period (S503).

Further, the prices of all tasks are accumulated on the basis of the price of each task (3303) calculated on the basis of the resource quantity in the customer-dependent function, the basal unit price of preset data 2 and the customer-dependent period. When there are contents pegged to customer needs from the contents price information, the price of the contents is calculated and added to the accumulated price of the tasks to thereby calculate the standard type design estimated price (S504). Thus, the standard type design is terminated (S505).

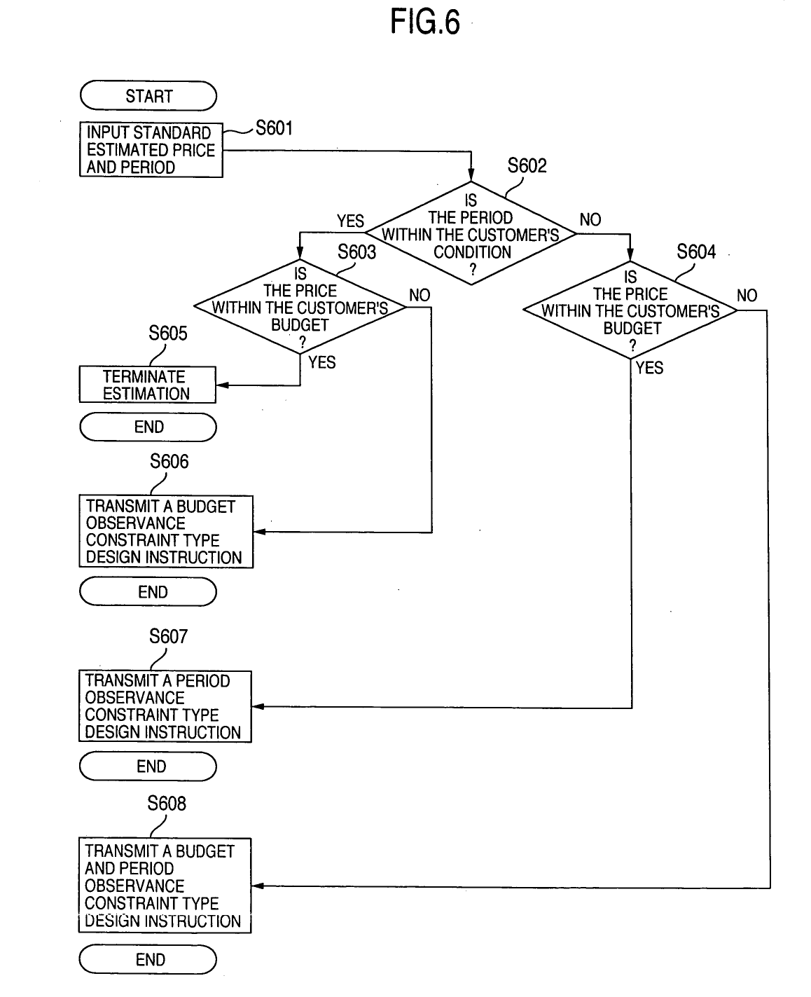

Here, the server computer 106 performs a flow of judgment as to whether the period observance constraint type/budget observance constraint type design is required or not, as shown in FIG. 6 on the basis of the estimated price and period of the standard type design and the customer budget and period. Incidentally, when the condition of the budget is zero or when the condition of the period is zero, a decision is made that the constraint type design is not required, and the following processing is performed.

First, the estimated price and period of the standard type design are input into the standard type design processing portion 109. A judgment is made as to whether the estimated period is not larger than the period of the customer condition (S602). When the estimated period is not larger than the customer period, the current position of processing goes to S603. When the estimated period is larger than the customer period, the current position of processing goes to S604. In S603, the estimated price is judged. When the estimated price is within the budget which is the customer condition, estimation is terminated (S605) and the current position of processing goes to transmission of solution specification design result data (S219). When the estimated price is higher than the budget, a budget observance constraint type design instruction is transmitted (S606) and the current position of processing goes to budget observance constraint type design (S217). In S604, the estimated price is judged in the same manner as in S603. When the estimated price is within the budget, a period observance constraint type design instruction is transmitted (S607) and the current position of processing goes to period observance constraint type design (S218). When the estimated price is higher than the budget, a budget observance constraint type and period observance constraint type instruction is transmitted (S608) and the current position of processing goes to budget observance constraint type design (S217) and then goes to period observance constraint type design (S218).

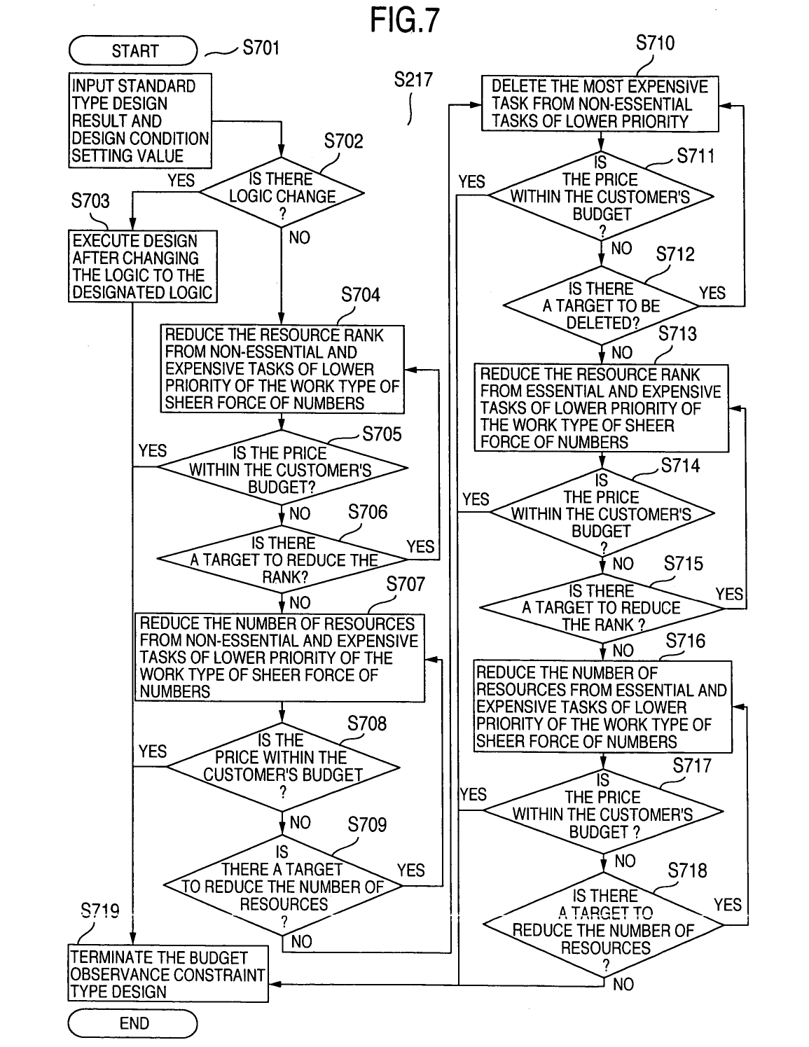

A basal flow of the budget observance constraint type design (S217) will be described with reference to FIG. 7. Assume that the lowest resource rank is E and the smallest number of resources is 1. Here, the standard type design result and the design condition setting value are input into the budget observance constraint type design processing portion 110 (S701). A judgment is made as to whether logic change is set on the solution condition setting screen (FIG. 28) or not (S702). When there is no change, processing is made by a default processing logic, that is, non-essential task resource rank change, non-essential task resource number change, task deletion, essential task resource rank change and essential task resource number change are processed in order. When there is any change, processing is performed by a customized logic (S703). Incidentally, because default is selected in this embodiment, description will be made below on the basis of an example of a basal flow of budget observance constraint type design (FIG. 7).

First, in the non-essential task resource rank change logic, non-essential solution tasks having the basal function type of preset data 2 corresponding to the work type 2 of sheer force of numbers are extracted and the resource rank of the most expensive task in tasks of lowest priority is reduced by one. On this occasion, with respect to a task with a plurality of resource ranks, the highest resource rank is reduced by one. Incidentally, when processing is repeated back from S706, a judgment is made as to whether the resource rank of the task can be further reduced by one. When the resource rank cannot be reduced, the resource rank of the second most expensive task in the tasks of lowest priority is reduced by one. When the resource rank of the task cannot be reduced by one, a judgment is made as to whether the third most expensive task is present in the tasks of lowest priority. When the third most expensive task is not present, the task priority is increased by one. The same procedure as described above is repeated (S704). When the resource rank reduced by one overlaps with the resource rank of originally lower priority, the number of resources is added up.

Thus, the resource quantity x of the task having the resource rank reduced by one is re-calculated. The price of the task is calculated on the basis of the basal unit price of preset data 2 and the customer-dependent period. When this change brings the estimated price within the customer budget, the design is terminated (S719). When the estimated price exceeds the customer budget yet (S705), a judgment is made as to whether there is a next task having the resource rank allowed to be reduced. When there is the next task, the current position of processing goes back to S704 to repeat processing. When there is no next task, the current position of processing goes to the non-essential task resource number change logic (S706).

Then, in the non-essential task resource number change logic (S707), the number of resources in the most expensive task in tasks of lowest priority extracted as descried above is reduced by one. Incidentally, when processing is repeated back from S709, a judgment is made as to whether the number of resources in the task can be further reduced by one. When the number of resources cannot be reduced, the number of resources in the second most expensive task in the tasks of lowest priority is reduced by one. When the number of resources in the task cannot be further reduced by one, the number of resources in the third most expensive task in the tasks of lowest priority is reduced by one. When there is no task, the task priority is increased by one. The same procedure as described above is repeated (S707).

Thus, the resource quantity x of the task having the resource number reduced by one is re-calculated. The price of the task is calculated on the basis of the basal unit price of preset data 2 and the customer-dependent period. When this change brings the estimated price within the customer budget, the design is terminated (S719). When the estimated price exceeds the customer budget yet (S708), a judgment is made as to whether there is a next task having the resource number allowed to be reduced. When there is the next task, the current position of processing goes back to S707 to repeat processing. When there is no next task, the current position of processing goes to the task deletion logic (S709).

Then, in the task deletion logic (S710), non-essential solution tasks are extracted and the most expensive task in tasks of lowest priority is deleted (S710). When this change brings the estimated price within the customer budget, the design is terminated (S719). When the estimated price exceeds the customer budget yet (S711), a judgment is made as to whether there is a next task allowed to be deleted. When there is the next task, the current position of processing goes back to S710 to repeat processing. When there is no next task, the current position of processing goes to the essential task resource rank change logic (S712). When the estimated price still exceeds the budget in spite of this change, resources for essential tasks are changed.

In the essential task resource rank change logic (S713), essential solution tasks having the basal function type of preset data 2 corresponding to the work type 2 of sheer force of numbers are extracted and the resource rank of the most expensive task in tasks of lowest priority is reduced by one. On this occasion, with respect to a task with a plurality of resource ranks, the highest resource rank is reduced by one. Incidentally, when processing is repeated back from S715, a judgment is made as to whether the resource rank of the task can be further reduced by one. When the resource rank cannot be reduced, the resource rank of the second most expensive task in the tasks of lowest priority is reduced by one. When the resource rank of the task cannot be reduced by one, a judgment is made as to whether the third most expensive task is present in the tasks of lowest priority. When the third most expensive task is not present, the task priority is increased by one. The same procedure as described above is repeated (S713). When the resource rank reduced by one overlaps with the resource rank of originally lower priority, the number of resources is added up.

Thus, the resource quantity x of the task having the resource rank reduced by one is re-calculated. The price of the task is calculated on the basis of the basal unit price of preset data 2 and the customer-dependent period. When this change brings the estimated price within the customer budget, the design is terminated (S719). When the estimated price exceeds the customer budget yet (S714), a judgment is made as to whether there is a next task having the resource rank allowed to be reduced. When there is the next task, the current position of processing goes back to S713 to repeat processing. When there is no next task, the current position of processing goes to the non-essential task resource number change logic (S715). Then, in the essential task resource number change logic, the number of resources in the most expensive task in tasks of lowest priority extracted as descried above is reduced by one.

Incidentally, when processing is repeated back from S718, a judgment is made as to whether the number of resources in the task can be further reduced by one. When the number of resources cannot be reduced, the number of resources in the second most expensive task in the tasks of lowest priority is reduced by one. When the number of resources in the task cannot be further reduced by one, the number of resources in the third most expensive task in the tasks of lowest priority is reduced by one. When there is no task, the task priority is increased by one. The same procedure as described above is repeated (S716).

Thus, the resource quantity x of the task having the resource number reduced by one is re-calculated. The price of the task is calculated on the basis of the basal unit price of preset data 2 and the customer-dependent period. When this change brings the estimated price within the customer budget, the design is terminated (S719). When the estimated price exceeds the customer budget yet (S717), a judgment is made as to whether there is a next task having the resource number allowed to be reduced. When there is the next task, the current position of processing goes back to S716 to repeat processing. When there is no next task, the current position of processing goes to termination of the budget observance constraint type design (S718). Thus, the budget observance constraint type design is terminated (S719). Incidentally, the logic is an example and it is possible to add a logic to the logic and change the logic.

Next, a basal flow of the period observance constraint type design (S218) will be described with reference to FIG. 8. Assume that the highest resource rank is A, the number of resources with A is 1 at maximum, the number of resources is increased by one with respect to the sum of numbers of original resources in accordance with each task, and the variable n in each logic in the basal flow of the period observance constraint type design (FIG. 8) is 2. Incidentally, these conditions can be changed.

Here, the standard type design result, the design condition setting value and the solution menu definition data (FIG. 10) are input into the period observance constraint type design processing portion 111 (S801). A judgment is made as to whether logic change is set on the solution condition setting screen (FIG. 28) or not (S802). When there is no change, processing is performed by a default processing logic, that is, essential task resource rank change, essential task resource number change, non-essential task resource rank change, non-essential task resource number change and task deletion are processed in order. When there is any change, processing is performed by a customized logic (S803). Incidentally, because default is selected in this embodiment, description will be made on the basis of an example of a basal flow of period observance constraint type design (FIG. 8).

First, in the essential task resource rank change logic, essential solution tasks having the longest customer-dependent period in each task lane and having the basal function type of preset data 2 corresponding to the work type 2 of sheer force of numbers are extracted and the resource rank of the task a having the longest customer-dependent period in the extracted tasks is increased so that the customer-dependent period of the task α becomes equal to the customer-dependent period of the task β having the second longest customer-dependent period in the tasks which are present in the same task lane as the task α. On this occasion, y is set to be the customer-dependent period of the task β by use of the period observance constraint type design customer-dependent function and the resource rank is used as a variable increased one by one. In a task having a plurality of resource ranks, the lowest resource rank is increased by one.

Incidentally, when the period cannot reach the second longest customer-dependent period even though the resource rank is increased to A, the customer-dependent period calculated as described above is set as the customer-dependent period of the task α. Incidentally, when n is equal to 3, the resource ranks of the tasks α and β are increased so that the customer-dependent periods of the tasks α and β are shortened so as to become equal to the customer-dependent period of the task having the third longest customer-dependent period. When the period cannot be reduced to the customer-dependent period of the task β even though the resource rank is increased to A as described above, the third process is not performed.

When there is no other task in the same task lane in which the task is present, all the resource ranks in the task are increased by two by processing different from the aforementioned processing. Of course, the numerical value can be changed (S804).

When this change brings the estimated period within the customer schedule, the design is terminated (S819). When the estimated period exceeds the customer schedule yet (S805), a judgment is made as to whether there is a remaining of the tasks extracted in S804. The current position of processing goes back to S804 when there is the remaining task, but the current position of processing goes to S807 when there is no remaining task (S806).

Then, in the essential task resource number change logic, essential solution tasks having the longest customer-dependent period in each task lane and having the basal function type of preset data 2 corresponding to the work type 2 of sheer force of numbers are extracted and the number of resources in a task α having the longest customer-dependent period in the extracted tasks is increased so that the customer-dependent period of the task α becomes equal to the customer-dependent period of a task β having the second longest customer-dependent period (next to the task α) in the tasks present in the same task lane as the task α. On this occasion, y is set to be the customer-dependent period of the task β by use of the period observance constraint type design customer-dependent function and the number of resources is used as a variable increased one by one. In a task having a plurality of resource ranks, the number of resources with the lowest resource rank is increased by one.

Incidentally, when the period cannot reach the second longest customer-dependent period even though the number of resources is increased to the prerequisite, the customer-dependent period calculated as described above is set as the customer-dependent period of the task α. Incidentally, when n is equal to 3, the number of resources in the tasks α and β are increased so that the customer-dependent periods of the tasks α and β are shortened so as to become equal to the customer-dependent period of the task having the third longest customer-dependent period. When the period cannot be reduced to the customer-dependent period of the task β even though the number of resources is increased to the prerequisite as described above, the third process is not performed. After that, when n is larger than 3, the same processing as described above is performed.

When there is no other task in the same task lane in which the task is present, all the numbers of resources is increased by one by processing different from the aforementioned processing. Of course, the numerical value can be changed (S807).

When this change brings the estimated period within the customer schedule, the design is terminated (S819). When the estimated period exceeds the customer schedule yet (S808), a judgment is made as to whether there is a remaining of the tasks extracted in S807. The current position of processing goes back to S807 when there is the remaining task, but the current position of processing goes to S810 when there is no remaining task (S806).

Then, in the non-essential task resource rank change logic, non-essential solution tasks having the longest customer-dependent period in each task lane and having the basal function type of preset data 2 corresponding to the work type 2 of sheer force of numbers are extracted and the resource rank of a task α having the longest customer-dependent period in the extracted tasks is increased so that the customer-dependent period of the task α becomes equal to the customer-dependent period of a task β having the second longest customer-dependent period (next to the task α) in the tasks present in the same task lane as the task α. On this occasion, y is set to be the customer-dependent period of the task β by use of the period observance constraint type design customer-dependent function and the resource rank is used as a variable increased one by one. In a task having a plurality of resource ranks, the lowest resource rank is increased by one.

Incidentally, when the period cannot reach the second longest customer-dependent period even though the resource rank is increased to A, the customer-dependent period calculated as described above is set as the customer-dependent period of the task α. Incidentally, when n is equal to 3, the resource ranks in the tasks α and β are increased so that the customer-dependent periods of the tasks α and β are shortened so as to become equal to the customer-dependent period of the task having the third longest customer-dependent period. When the period cannot be reduced to the customer-dependent period of the task β even though the resource rank is increased to A as described above, the third process is not performed.

When there is no other task in the same task lane in which the task is present, all the resource ranks in the task are increased by two by processing different from the aforementioned processing. Of course, the numerical value can be changed (S810).

When this change brings the estimated period within the customer schedule, the design is terminated (S819). When the estimated period exceeds the customer schedule yet (S811), a judgment is made as to whether there is a remaining of the tasks extracted in S810. The current position of processing goes back to S810 when there is the remaining task, but the current position of processing goes to S813 when there is no remaining task (S812).

Then, in the non-essential task resource number change logic, non-essential solution tasks having the longest customer-dependent period in each task lane and having the basal function type of preset data 2 corresponding to the work type 2 of sheer force of numbers are extracted and the number of resources in a task α having the longest customer-dependent period in the extracted tasks is increased so that the customer-dependent period of the task α becomes equal to the customer-dependent period of a task β having the second longest customer-dependent period (next to the task α) in the tasks present in the same task lane as the task α. On this occasion, y is set to be the customer-dependent period of the task β by use of the period observance constraint type design customer-dependent function and the number of resources is used as a variable increased one by one. In a task having a plurality of resource ranks, the number of resources with the lowest resource rank is increased by one.

Incidentally, when the period cannot reach the second longest customer-dependent period even though the number of resources is increased to the prerequisite, the customer-dependent period calculated as described above is set as the customer-dependent period of the task α. Incidentally, when n is equal to 3, the number of resources in the tasks α and β are increased so that the customer-dependent periods of the tasks α and β are shortened so as to become equal to the customer-dependent period of the task having the third longest customer-dependent period. When the period cannot be reduced to the customer-dependent period of the task β even though the number of resources is increased to the prerequisite as described above, the third process is not performed.

When there is no other task in the same task lane in which the task is present, all the numbers of resources is increased by one by processing different from the aforementioned processing. Of course, the numerical value can be changed (S813).

When this change brings the estimated period within the customer schedule, the design is terminated (S819). When the estimated period exceeds the customer schedule yet (S814), a judgment is made as to whether there is a remaining of the tasks extracted in S813. The current position of processing goes back to S813 when there is the remaining task, but the current position of processing goes to S816 when there is no remaining task (S815).

Then, in the task deletion logic, non-essential solution tasks are extracted and a task having the longest customer-dependent period in tasks of lowest priority is deleted (S816).

When this change brings the estimated period within the customer schedule, the design is terminated (S819). When the estimated period exceeds the customer schedule yet (S817), a judgment is made as to whether there is a next task allowed to be deleted. When there is the next task, the current position of processing goes back to S816 to repeat processing. When there is no next task, the period observance constraint type design is terminated (S818).

Incidentally, the aforementioned logic is only an example and it is possible to add a logic to the logic and change the logic.

In this manner, the budget observance constraint type design and the period observance constraint type design are terminated in the server computer 106 and the current position of processing goes to transmission of result data (S219).

In the transmission of result data, the server computer 106 transmits result data containing at least one of a result of the standard type design, a result of the budget observance constraint type design and a result of the period observance constraint type design to the client computer 101 waiting for reception of result data (S220) to thereby display the result (S221) and the server computer 106 goes to a state for waiting for reception of setting change data (S225).

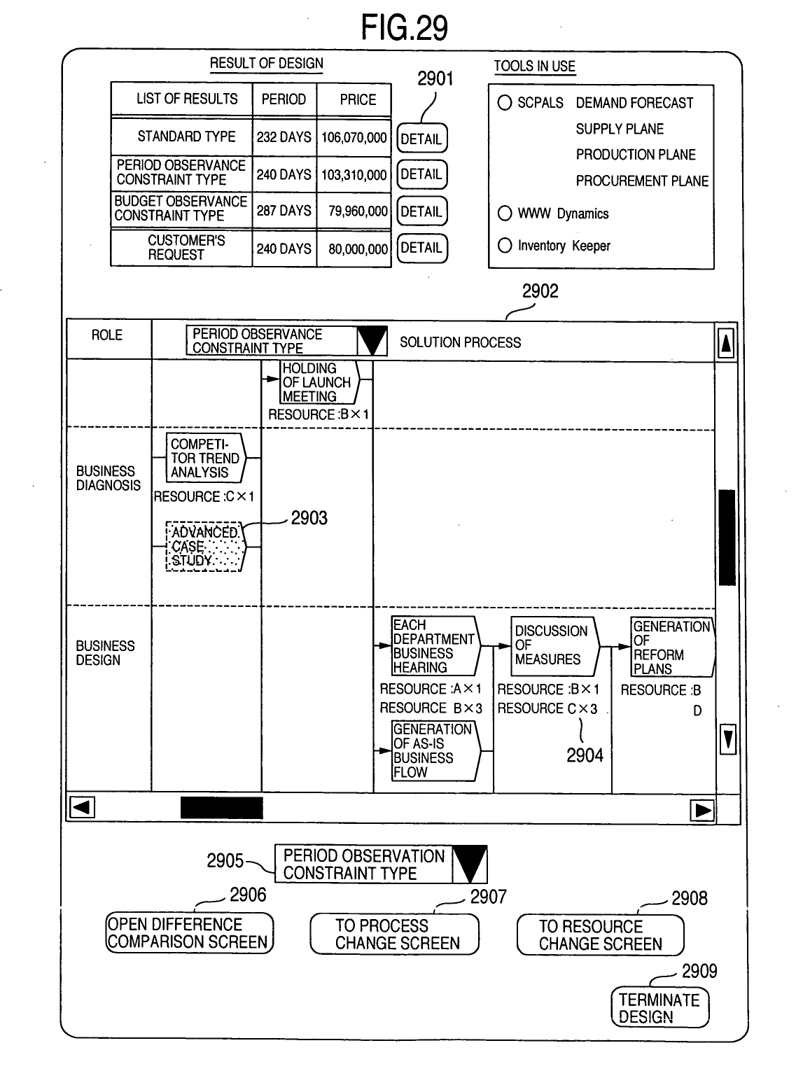

In the display of the result, the client computer 101 receives image data generated on the basis of the result data by the server computer 106 and displays the solution design result display screen (FIG. 29). The user can confirm the design result, tools used and solution processes. When the user pushes the button 2901, the user can confirm a detailed result (estimated price and period each solution task) corresponding to the result data.

In the display screen example, a solution process of the period observance constraint type design is displayed. When the user changes the subject of display on the pull-down menu 2902, the client computer 101 displays a solution process for the subject of display.

Particularly in display of solution processes of the budget observance constraint type design and the period observance constraint type design, the user can grasp the difference between the constraint type design result and the standard type design result.

For example, the solution task 2903 tenuously displayed by the client computer 101 receiving the image data of the design result generated on the basis of the result data, the resource allocation 3306, the deletion flag 3307, the change flag 3308, etc. by the server computer 106 is present in the standard type design but the solution task 2903 means a deleted task in the period observance constraint type design. Information such as the solution task 2904 emphatically displayed on the basis of the display data by the client computer 101 among the resource information displayed in accordance with each solution task means that the resource rank or the number of resources is changed as against the standard type design.

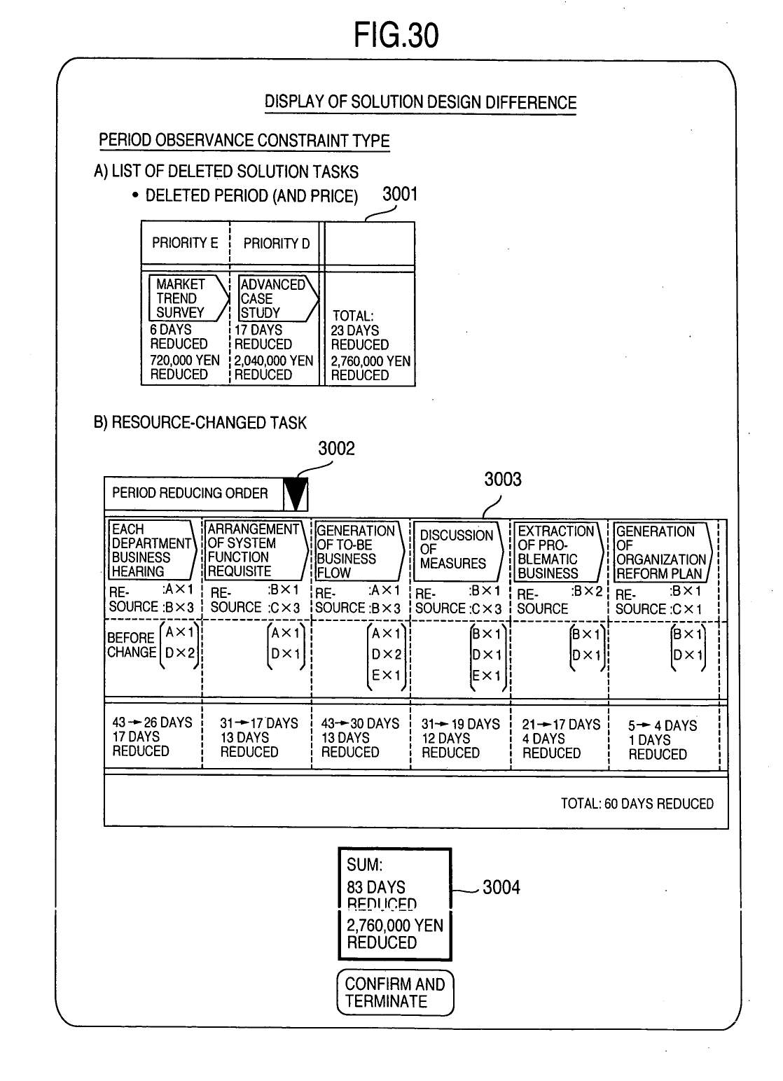

When the user wants to confirm the details of the difference information, the user can select the period observance constraint type on the pull-down menu 2905 and pushes the button 2906 so that the solution design difference display screen data generated on the basis of the solution design result difference data by the server computer 106 can be received and displayed by the client computer 101 (FIG. 30).

On the screen, the user can confirm a list 3001 of deleted solution tasks, a list of tasks with changed resources in which the way of display can be changed by the pull-down menu 3002, resource information 3003 before and after the change of each task and information 3004 of the standard design and the change of the period and budget by deletion of each task and change of resources.

Of course, if the user selects the budget observance constraint type from the pull-down menu 2905, the user can confirm information of difference between the budget observance constraint type design result and the standard type design result.

Incidentally, if the user wants to perform solution design again on the basis of the result displayed on the solution design result display screen and the solution design difference display screen, the user can push the button 2907 to go to acceptance of solution process change result (S222) to change the solution process and can push the button 2908 to go to acceptance of resource setting change result (S223) to change resources each task. When the user wants to terminate the design, the user can push the button 2909 so that the client computer 101 generates a termination instruction (S227) and goes to acceptance of output method selection result (S228).

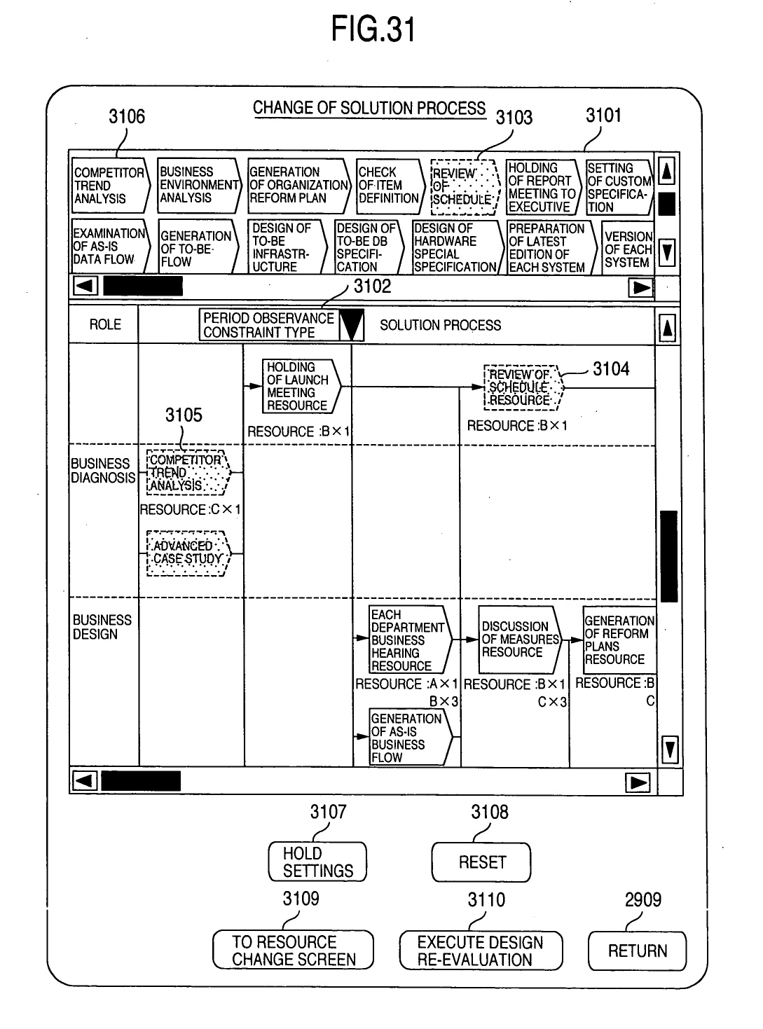

First, in the acceptance of solution process change result in S222, the user can add or delete a task or change the sequential relation or parallel relation between tasks on the screen (FIG. 31) displayed by the client computer 101 receiving the solution process change display screen data generated on the basis of the solution menu definition data, preset data 2 and solution design result difference data by the server computer 106.

In this embodiment, tasks not selected on the solution process are displayed in the region 3101. The user can add one of the tasks by a drag and drop operation. Incidentally, the subject of change can be changed to another design result by the pull-down menu 3102.

For example, the task 3103 tenuously displayed by the client computer 101 is added as a task 3104 on the solution process when the selection flag 1408 is generated for the task 3103. The task 3105 tenuously displayed is processed to be return to a solution task 3106 in the region 3101 when the selection flag 1408 is deleted for the task 3105.

Incidentally, if the-user wants to store these settings, the user can push the button 3107 so that the client computer 101 decides data in the change portion of preset data 2. If the user wants to return the change portion to its original state, the user can push the button 3108 to return data in the change portion of preset data 2 to a state before change.

To change resources each task in consideration of the change in this time, when the user pushes the button 3109, the current position of processing goes to acceptance of resource setting change result (S223). To re-evaluate the design, when the user pushes the button 3110, the client computer 101 transmits setting change data to the server computer 106 waiting for reception of setting change data (S224) and the server computer 106 executes re-calculation (S226). Then, the current position of processing goes back to step S219.

Incidentally, when the user pushes the button 3111, the display screen is returned to the solution design result display screen.

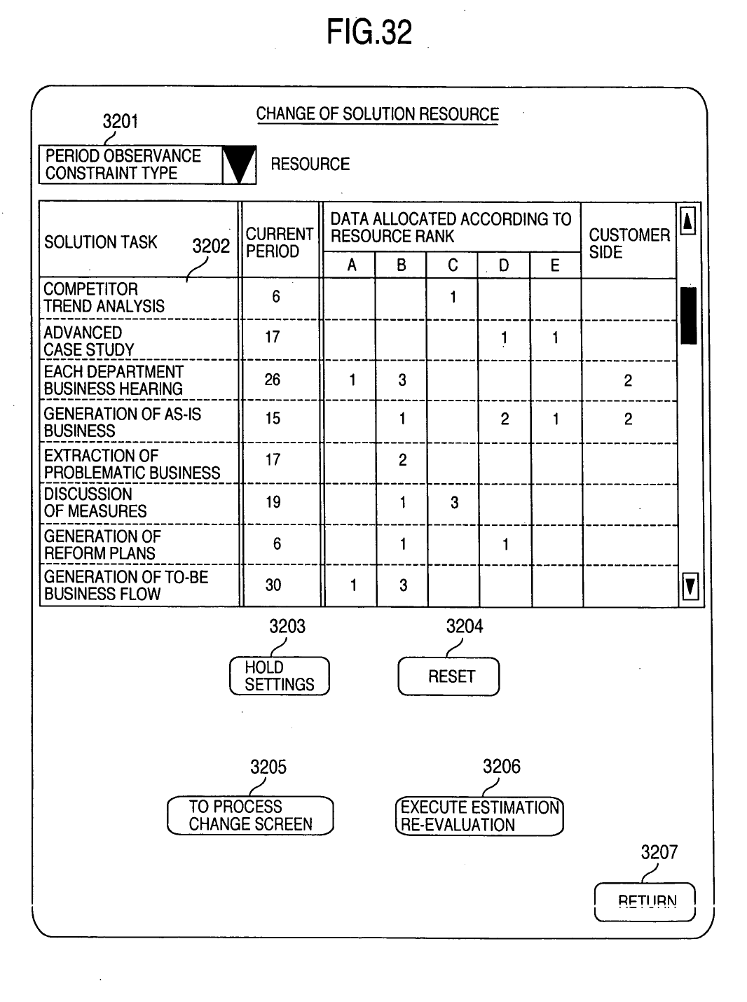

In the acceptance of resource setting change result in S223, the user can change allocation of resources each solution task on the display screen (FIG. 32) displayed by the client computer receiving the resource setting change display data generated on the basis of preset data 2 and solution design result difference data by the server computer 106.

Here, the solution task 3202 tenuously displayed on the basis of the display data by the client computer 101 means a task which is present in the standard type design but is deleted in the period observance constraint type design. Incidentally, the subject of change can be changed to another design result by the pull-down menu 3201.

To change a resource, the user can change the resource by inputting a numerical value corresponding to the resource rank or can change the resource by directly inputting the numerical value of a resource on the customer side.

To store the settings, when the user pushes the button 3203, the client computer 101 decides data in the change portion of solution design result difference data. To return the settings, when the user pushes the button 3108, the client computer 101 returns data in the change portion of solution design result difference data to data before change.

To change the solution process in consideration of the change in this timer, when the user pushes the button 3205, the current position of processing goes to acceptance of solution process change result (S222). To re-evaluate the design soon, when the user pushes the button 3206, the client computer 101 transmits setting change data to the server computer 106 waiting for reception of setting change data (S224) and the server computer 106 executes re-calculation (S226). Then, the current position of processing goes back to S219.

Incidentally, when the user pushes the button 3207, the display screen is returned to the solution design result display screen (FIG. 29).

In the acceptance of output method selection result in S228, the user sets an output method on the solution design result file output design screen.

Finally, when the user pushes the button to transmit a termination instruction, the client computer 101 transmits the termination instruction to the server computer 106 waiting for reception of the termination instruction (S229). The server computer 106 outputs the result by a method designated in any one of the case where the user wants to output the design result as only one file, the case where the user wants to output the design result as a file and data interlocked with the item system and the case where the user does not want to output any file (S230). When there are the result file and data interlocked with the item system, the server computer 106 transmits the result file and data to the data storage device 115 and the client computer 101 respectively (S231). The result file is displayed on the output portion 103 of the client computer 101 waiting for reception of the result file (S232).

As described above, in accordance with the embodiment, there can be provided a method for changing the condition on the basis of the customer reform phase and customer needs and outputting a solution process, allocation of resources each solution task and the estimated price and period simultaneously in a short time with the customer budget and period as constraints.

1. A solution design method using a calculation execution portion in which simulation software for calculation of solution design is installed, and a user operation portion connected to the calculation execution portion, the method comprising the steps of:
narrowing a solution menu necessary for a customer by inputting customer reform phase data indicating the stage of management reform of the customer from the user operation portion (solution menu narrowing step);
selecting a task to be executed in solution from the narrowed solution menu and setting the degree of significance of the task (solution task selection step);
setting solution design conditions of a budget, a period and a design logic as customer's constraints (solution design condition setting step);
re-defining resource rank definition data in accordance with a customer's request to perform solution design in a customer-dependent condition on the basis of data concerned with the solution design conditions and the customer's request (resource rank calculation processing step);
calculating a customer-dependent period each task as a period necessary for execution of the task and calculating a customer-dependent function to set allocation of resources on the basis of the customer-dependent period and the shape of a basal function (customer-dependent period and function calculation processing step);
performing solution design in accordance with the customer's request in a non-constraint condition on the basis of data concerned with the customer's request, the solution task and the customer-dependent function (standard type design processing step);
performing solution design with the budget which is a constraint condition of the customer, as a constraint condition (budget observance constraint type design processing step);
performing solution design with the period which is a constraint condition of the customer, as a constraint condition (period observance constraint type design processing step);
performing solution design again by adding/deleting solution tasks to/from processing results generated by the standard type design processing step, the budget observance constraint type design processing step and the period observance constraint type design processing step and by changing allocation of resources each task and setting customer resources (re-calculation execution step); and
outputting a result of solution design as a file and item management data to a data storage device (result output step).

2. A solution design method according to claim 1, wherein the result output step outputs different solution tasks, allocation of resources each task, a difference between prices and a difference between periods as a result of the standard type design and a result of the budget observance constraint type design or the period observance constraint type design.

3. A solution design method according to claim 1, wherein each of the standard type design processing step, the budget observance constraint type design processing step and the period observance constraint type design processing step simultaneously outputs a solution process in which tasks to be executed in solution are arranged in order of execution, a period, allocation of resources and a price necessary for execution of each task, types of hardware and software used, and a price and a period required between start of the solution and completion of the solution.

4. A solution design method according to claim 1, wherein:
one of the solution tasks or a set of the solution tasks is a solution flow;
one of the solution flows or a set of the solution flows is the solution menu; and
the solution menu has business diagnosis/design consulting concerned with examination and analysis of current business and design of new business, business system construction concerned with design/development/implementation of a new business system, project management for managing a project at the time of execution of solution, infrastructural system construction concerned with examination and analysis of a current infrastructural system and design/development/implementation of a new infrastructural system, software implementation concerned with provision/development of software, hardware implementation concerned with provision/development of hardware, operation and maintenance for maintenance/inspection of system or hardware and operation of out-sourcing business, and implementation construction.

5. A solution design method according to claim 1, wherein in some case, each of the standard type design processing step, the budget observance constraint type design processing step and the period observance constraint type design processing step performs design by using only SCOPE data which are essential data such as the type of industry, the number of workers in each base, the number of bases to be reformed, and business to be reformed, and in some case, each of the standard type design processing step, the budget observance constraint type design processing step and the period observance constraint type design processing step performs design by using the SCOPE data and at least one of FOCUS data which are selection data such as rate of observance of required delivery date, improvement in ROA, improvement in cash to cash cycle time, reduction in the number of inventory days, and the number of users.

6. A solution design method according to claim 1, wherein data concerned with the customer's request in the standard type design processing step has SCOPE information, and FOCUS information.

7. A solution design method according to claim 1, wherein each of the budget observance constraint type design processing step and the period observance constraint type design processing step can perform design while changing the combination of a plurality of design logics.

8. A solution design method according to claim 7, wherein the design logics include a non-essential task resource rank change logic, an essential task resource rank change logic, a non-essential task resource number change logic, an essential task resource number change logic, a task deletion logic, and a customer resource setting logic.

9. A solution design method according to claim 1, wherein:
in the standard type design processing step, the solution tasks are classified into four business types, namely, a work type of expert in which no one except an expert can do, a work type of sheer force of numbers in which two or more resources are substantially processed simultaneously in parallel, a work type of the able minority in which efficiency is typically lowered when the number of persons becomes large, and a work type of customer dependence which is operated substantially in accordance with the customer's situation; and
the shape of a function is defined as a basal function for each business type so that a period, the number of resources and resource ranks necessary for execution of the solution task are calculated by the basal function.

10. A solution design method according to claim 1, wherein:
in the resource rank calculation processing step, the rank of each resource is defined on the basis of an essential fixed condition such as the number of years of solution experience, and the post of solution experience such as a project manager and a team leader; an essential needs-dependent condition such as solution execution skill for business diagnosis consulting, tool integration, etc., solution knowledge information based on sales business knowledge and production planning business knowledge, and solution scale experience information based on experience of a budget scale of solution; and a selection needs-dependent condition such as solution multi-base experience information based on the number of bases in one time in experience of solution, solution overseas base experience information based on the degree of overseas solution experience, and skill information of English conversation; and
customer-dependent resource ranks are re-defined in accordance with the customer's request on the basis of data concerned with the customer's request and the solution design condition of the budget as a constraint condition of the customer.

11. A solution design method according to claim 1, wherein:
in the resource rank calculation processing step, the number of resources each task is calculated to examine correspondence between the resource rank and the actual resource on the basis of the data having the re-defined resource ranks; and
in each of the standard type design processing step, the budget observance constraint type design processing step and the period observance constraint type design processing step, a list of numbers of necessary resources in accordance with the resource ranks and the over-and-short number of resources at the present time are calculated as the design result.

12. A solution design method according to claim 11, wherein solution design is performed once or several times at pleasure whenever SCOPE information and FOCUS information are changed with respect to each customer in a period of from before trade inquiry to acceptance of an order and agreement.

13. A solution design calculation system comprising:
a solution menu narrowing portion for narrowing a solution menu necessary for a customer on the basis of customer reform phase data input from an user operation portion and indicating the stage of management reform that the customer is in;
a solution task selection portion for selecting a task to be executed in solution from the narrowed solution menu and setting the degree of significance of the task;
a solution design condition setting portion for setting solution design conditions of a budget, a period and a design logic as constraint conditions of the customer;
a resource rank calculation processing portion for re-defining resource rank definition data in accordance with the customer's request to perform solution design in a customer-dependent condition on the basis of the solution design condition and data concerned with the customer's request;
a customer-dependent period and function calculation processing portion for calculating a customer-dependent period necessary for execution of each task and calculating a customer-dependent function for setting allocation of resources on the basis of the customer-dependent period and the shape of a basal function;
a standard type design processing portion for performing solution design in accordance with the customer's request without any constraint on the basis of the data concerned with the customer's request, the solution task and the customer-dependent function;
a budget observance constraint type design processing portion for performing solution design while a budget which is a constraint of the customer is used as a constraint;
a period observance constraint type design processing portion for performing solution design while a period which is a constraint of the customer is used as a constraint;
a re-calculation execution portion for performing solution design again after addition or deletion of a solution task, change of allocation of resources each task and setting of customer resources with respect to processing results due to the standard type design processing portion, the budget observance constraint type design processing portion and the period observance constraint type design processing portion; and
a result output portion for outputting a solution design result as a file and item management data toga data storage device.

14. A solution design calculation system according to claim 13, wherein in the result output portion, different solution tasks, allocation of resources each task, difference between prices and difference between periods are output as a result of the standard type design, a result of the budget observance constraint type design or a result of the period observance constraint type design.

15. A solution design calculation system according to claim 13, wherein in each of the standard type design processing portion, the budget observance constraint type design processing portion and the period observance constraint type design processing portion, a solution process in which tasks to be executed in solution are arranged in order of execution, a period, allocation of resources and a price necessary for execution of each task, the type of hardware and software used, and a price and a period required between start of the solution and completion of the solution are output simultaneously.

16. A solution design calculation system according to claim 13, wherein in each of the standard type design processing portion, the budget observance constraint type design processing portion and the period observance constraint type design processing portion, in some case, design is performed by use of only SCOPE data which are essential information such as the type of industry, the number of workers in each base, the number of bases to be reformed, and business to be reformed, and in some case, design is performed by the SCOPE data and at least one of FOCUS data which are selection information such as rate of observance of required delivery date, improvement in ROA, improvement in cash to cash cycle time, reduction in number of inventory days, and the number of users.

17. A solution design calculation system according to claim 13, wherein each of the budget observance constraint type design processing portion and the period observance constraint type design processing portion is configured so that design can be performed while a combination of a plurality of design logics is changed.

18. A solution design calculation system according to claim 13, wherein:
in the resource rank calculation processing portion, the number of resources each task is calculated to examine correspondence between the resource rank and the actual resource on the basis of the data having the re-defined resource ranks; and
in each of the standard type design processing portion, the budget observance constraint type design processing portion and the period observance constraint type design processing portion, a list of numbers of necessary resources in accordance with the resource ranks and the over-and-short number of resources at the present time are calculated as the design result.

19. A recording medium containing a solution design program with a computer code for executing steps of a solution design method by using a calculation execution portion and a user operation portion connected to the calculation execution portion when read into a computer system, the solution design method including the steps of:
narrowing a solution menu necessary for a customer by inputting customer reform phase data indicating the stage of management reform of the customer from the user operation portion (solution menu narrowing step);
selecting a task to be executed in solution from the narrowed solution menu and setting the degree of significance of the task (solution task selection step);
setting solution design conditions of a budget, a period and a design logic as customer's constraints (solution design condition setting step);
re-defining resource rank definition data in accordance with a customer's request to perform solution design in a customer-dependent condition on the basis of data concerned with the solution design conditions and the customer's request (resource rank calculation processing step);
calculating a customer-dependent period each task as a period necessary for execution of the task and calculating a customer-dependent function to set allocation of resources on the basis of the customer-dependent period and the shape of a basal function (customer-dependent period and function calculation processing step);
performing solution design in accordance with the customer's request in a non-constraint condition on the basis of data concerned with the customer's request, the solution task and the customer-dependent function (standard type design processing step);
performing solution design with the budget which is a constraint condition of the customer, as a constraint condition (budget observance constraint type design processing step);
performing solution design with the period which is a constraint condition of the customer, as a constraint condition (period observance constraint type design processing step);
performing solution design again by adding/deleting solution tasks to/from processing results generated by the standard type design processing step, the budget observance constraint type design processing step and the period observance constraint type design processing step and by changing allocation of resources each task and setting customer resources (re-calculation execution step); and
outputting a result of solution design as a file and item management data to a data storage device (result output step).

20. A solution design method according to claim 1, wherein solution design is performed once or several times at pleasure whenever SCOPE information and FOCUS information are changed with respect to each customer in a period of from before trade inquiry to acceptance of an order and agreement.
